(19) United States
(12) Patent Application Publication
(10) Pub. No.: US 2007/0024920 A1
(43) Pub. Date: Feb. 1, 2007

(54) Image processing device, image formation device, and image processing method

(76) Inventors: Nobuya Kishi, Yamatokoriyama-shi (JP); Takateru Yamamoto, Uji-shi (JP); Yosuke Kashu, Hyogo (JP); Sumitaka Arikawa, Souraku-gun (JP); Yukari Ebi, Souraku-gun (JP)

Correspondence Address: BIRCH STEWART KOLASCH & BIRCH, PO BOX 747, FALLS CHURCH, VA, 22040-0747, US

(21) Appl. No.: 10/571,136

(22) PCT Filed: Aug. 31, 2004
(86) PCT No.: PCT/JP04/12539

§ 371 Date: Mar. 9, 2006

(30) Foreign Application Priority Data
Sep. 17, 2003 (JP) 2003-324972

(51) Int. Cl. H04N 1/23

(52) U.S. Cl. 358/448; 358/296

(57) ABSTRACT

As for read-out image data of a manuscript, image regions not requiring color output are specified as specified regions 1 and 2. Then, it is determined whether the color information of the pixels of the read-out image data outside the specified regions 1 and 2 is achromatic. When it is determined as achromatic, the read-out manuscript is determined as a monochrome manuscript, so that processed image data in which chromatic pixels of the read-out image data in the specified regions 1 and 2 are converted into achromatic pixels is outputted as achromatic (monochrome) data. On the other hand, when it is determined as not achromatic, the read-out manuscript is determined as a color manuscript, so that the read-out image data is outputted intact as chromatic (color) data.

This application is the national phase under 35 U.S.C. § 371 of PCT International Application No. PCT/JP2004/012539 which has an International filing date of Aug. 31, 2004 and designated the United States of America.

### TECHNICAL FIELD

The present invention relates to an image processing method and an image processing apparatus for processing read-out image data of a read-out manuscript as well as an image forming apparatus employing this image processing apparatus, and in particular to an image processing method and an image processing apparatus for restricting the chromatic (color) output of pixels in a predetermined region of the read-out image data of a color manuscript as well as an image forming apparatus employing this image processing apparatus and thereby restricting chromatic (color) image formation.

### BACKGROUND ART

In some prior art image processing apparatuses, the read-out image data of a read-out manuscript is determined whether chromatic (color) or achromatic (monochrome) on a pixel basis, so that the read-out manuscript is determined whether a color manuscript or a monochrome manuscript (see, for example, Patent Document 1).

Further, some prior art image forming apparatuses have the function of switching whether the image formation of the read-out image data of a read-out manuscript should be performed in color or monochrome. In some of these apparatuses, a plurality of manuscript sheets composed of color manuscript sheets and monochrome manuscript sheets in a mixed state are successively read in a color image formation mode, and then when read-out image data changes from chromatic (color) data into achromatic (monochrome) data, disadvantages that would arise in the case that the achromatic read-out image data is processed intact in the color image formation mode are compared with disadvantages that would arise in the case that the achromatic read-out image data is processed after the image formation mode is switched into monochrome. Then, on the basis of the determination result of the disadvantageousness, the achromatic read-out image data is processed intact in the color image formation mode, or alternatively the image formation is performed after the mode is switched into monochrome. According to this approach, regardless of the mixed state of color manuscript sheets and monochrome manuscript sheets, the life is enhanced in a photosensitive drum and consumable supplies such as toner, while their utilization efficiency is improved (see, for example, Patent Document 2).
[Patent Document 1] Japanese Patent Application Laid-Open No.2001-36752
[Patent Document 2] Japanese Patent Application Laid-Open No.2000-29266

### DISCLOSURE OF THE INVENTION

Meanwhile, even in a color manuscript, in some cases, a majority of the entirety is monochrome while merely a part is in color. Such manuscripts include: a document manuscript in which a logo mark such as a company name and a company mark is solely in color; and a slide sheet or OHP sheet for presentation in which a background mark is solely in color. In the case of inner-company use or private use, almost no advantage is obtained even when such a logo mark or a background mark is outputted in color.

Nevertheless, in the image processing apparatus and the image forming apparatus disclosed respectively in Patent Documents 1 and 2, determination whether a color manuscript or a monochrome manuscript is performed on the basis of the entire read-out image data. Thus, even for a manuscript in which a part intrinsically not requiring color output is solely in color (referred to as a partly colored manuscript, hereafter), its read-out image data is determined as a color manuscript so that color output is performed. This causes the problem of an increase in the amount of output image data. Further, another problem arises that the unnecessary color output causes an increase in the image formation cost and degradation in the image formation speed.

The present invention has been devised in view of these problems. An object of the present invention is to provide an image processing method and image processing apparatus in which: specification of an arbitrary image region of the manuscript is received; then, it is determined whether pixels of the read-out image data in a region other than the received specified region are achromatic; and then, when determined as achromatic, chromatic pixels of the read-out image data in the specified region are converted into achromatic pixels, so that appropriate color manuscript/monochrome manuscript determination is achieved on the read-out manuscript, so that unnecessary color output is restricted while the amount of output image data can be reduced.

Another object of the present invention is to provide an image processing method and image processing apparatus in which: specification of an arbitrary image region of the manuscript is received; and then, chromatic pixels of the read-out image data in the received specified region are converted into achromatic pixels, so that appropriate color manuscript/monochrome manuscript. determination is achieved on the read-out manuscript, so that unnecessary color output is restricted further, while the amount of output image data can be reduced further.

Another object of the present invention is to provide an image processing method and image processing apparatus in which: it is determined whether color information of pixels of the read-out image data corresponds to the color information of the pixels of chromatic image data generated by registering a chromatic image as data; and then, when determined as corresponding, chromatic pixels of the read-out image data corresponding to the color information of the pixels of the chromatic image data are converted into achromatic pixels, so that appropriate color manuscript/monochrome manuscript determination is achieved on the read-out manuscript, so that unnecessary color output is restricted on a pixel basis while the amount of output image data can be reduced.

Yet another object of the present invention is to provide an image forming apparatus employing the-above image processing apparatus in which consumable supplies such as color toner and color ink necessary for color image formation are prevented from being consumed uselessly, so that image formation cost is reduced while image formation speed is improved.

An image processing apparatus according to the present invention is an image processing apparatus comprising: reading means for reading a manuscript; processing means for processing read-out image data of the manuscript read by the reading means; and output means for outputting processed image data processed by the processing means, characterized by comprising: receiving means for receiving specification of an arbitrary image region of the manuscript; and determining means for determining whether pixels of the read-out image data in a region other than the specified region received by the receiving means is achromatic, wherein when the determining means determines as achromatic, the processing means converts chromatic pixels of the read-out image data in the specified region into achromatic pixels. An image processing method according to the present invention is an image processing method of reading a manuscript and then processing read-out image data of the read-out manuscript, characterized by comprising the steps of receiving specification of an arbitrary image region of the manuscript; determining whether pixels of the read-out image data in a region other than the received specified region are achromatic; and converting chromatic pixels of the read-out image data in the specified region into achromatic pixels, when determined as achromatic.

In the image processing method and the image processing apparatus according to the present invention, the receiving means receives specification of an arbitrary image region of the manuscript from a user. Then, the determining means determines whether pixels of the read-out image data in a region other than the specified region received by the receiving means is achromatic. Then, only when the determining means determines as achromatic, the processing means converts chromatic pixels of the read-out image data in the specified region into achromatic pixels. Thus, when the user specifies as an image region the region of a logo mark or a background mark, as for a manuscript (partly colored manuscript) in which a logo mark or a background mark is solely in color, since pixels of the read-out image data other than the logo mark or the background mark are achromatic, such processed image data is outputted that chromatic pixels of the logo mark or the background mark have been converted into achromatic pixels. That is, a partly colored manuscript not requiring color output is appropriately determined as a monochrome manuscript, so that the entire read-out image data is outputted as achromatic (monochrome) data. By virtue of this, as for a manuscript in which a logo mark or a background mark is solely in color, color output of the read-out image data is restricted. This increases achromatic output, and hence reduces the amount of output image data. Similarly, as for a manuscript (color manuscript) having a colored part other than a logo mark or a background mark, since pixels of the read-out image data other than the logo mark or the background mark are chromatic, the manuscript is determined as a color manuscript. Thus, the chromatic pixels of the logo mark or the background mark are not converted into achromatic pixels. That is, the entire read-out image data is outputted intact as chromatic (color) data.

An image processing apparatus according to the present invention is an image processing apparatus comprising: reading means for reading a manuscript; processing means for processing read-out image data of the manuscript read by the reading means; and output means for outputting processed image data processed by the processing means, characterized by comprising receiving means for receiving specification of an arbitrary image region of the manuscript, wherein said processing means converts, into achromatic pixels, chromatic pixels of the read-out image data in the specified region received by the receiving means. An image processing method according to the present invention is an image processing method of reading a manuscript and then processing read-out image data of the read-out manuscript, characterized by comprising the steps of receiving specification of an arbitrary image region of the manuscript; and converting chromatic pixels of the read-out image data in the received specified region into achromatic pixels.

In the image processing method and the image processing apparatus according to the present invention, the receiving means receives specification of an arbitrary image region of the manuscript from a user. Then, the processing means converts, into achromatic pixels, chromatic pixels of the read-out image data in the specified region received by the receiving means. Thus, when a user specifies as an image region the region of a logo mark or a background mark, as for a manuscript (partly colored manuscript) in which a logo mark or a background mark is solely in color, such processed image data is outputted that chromatic pixels of the logo mark or the background mark have been converted into achromatic pixels. That is, a partly colored manuscript not requiring color output is determined appropriately as a monochrome manuscript, so that the entire read-out image data is outputted as achromatic (monochrome) data. By virtue of this, as for a manuscript in which a logo mark or a background mark is solely in color, color output of the read-out image data is restricted. This increases achromatic output, and hence reduces the amount of output image data. Similarly, as for a manuscript (color manuscript) having a colored part other than a logo mark or a background mark, such processed image data is outputted that chromatic pixels of the logo mark or the background mark have solely been converted into achromatic pixels. That is, a color manuscript is appropriately determined as a color manuscript and, still, pixels intrinsically not requiring color output are outputted as achromatic pixels. By virtue of this, even for a manuscript requiring color output, color output is performed in such a manner that a part such as a logo mark and a background mark not requiring color output is achromatized. This reduces image area, that is, the number of pixels, of color output, and hence reduces the amount of output image data.

An image processing apparatus according to the present invention is an image processing apparatus comprising: reading means for reading a manuscript; processing means for processing read-out image data of the manuscript read by the reading means; and output means for outputting processed image data processed by the processing means, characterized by comprising determining means for determining whether color information of pixels of the read-out image data corresponds to color information of pixels of chromatic image data generated by registering a chromatic image as data, wherein when the determining means determines as corresponding, said processing means converts, into achromatic pixels, chromatic pixels of the read-out image data corresponding to the color information of the pixels of the chromatic image data. An image processing method according to the present invention is an image processing method of reading a manuscript and then processing read-out image data of the read-out manuscript, characterized by comprising the steps of determining whether color information of pixels of the read-out image data corresponds to color information of pixels of chromatic image data generated by registering a chromatic image as data; and converting chromatic pixels of the read-out image data corresponding to the color information of the pixels of the chromatic image data, into achromatic pixels when determined as corresponding.

In the image processing method and the image processing apparatus according to the present invention, the determining means performs on a pixel basis the determination whether color information of pixels of the read-out image data corresponds to the color information of the pixels of the chromatic image data. Then, when the determining means determines as corresponding, the processing means converts, into achromatic pixels, chromatic pixels of the read-out image data corresponding to the color information of the pixels of the chromatic image data. Thus, when the chromatic image data is generated by registering a logo mark or a background mark as the data of a chromatic image, as for a manuscript (partly colored manuscript) in which a logo mark or a background mark is solely in color, such processed image data is outputted that chromatic pixels of the logo mark or the background mark have been converted into achromatic pixels. That is, a partly colored manuscript not requiring color output is appropriately determined as a monochrome manuscript, so that the entire read-out image data is outputted as achromatic (monochrome) data. By virtue of this, as for a manuscript in which a logo mark or a background mark is solely in color, color output of the read-out image data is restricted. This increases achromatic output, and hence reduces the amount of output image data. Similarly, as for a manuscript (color manuscript) having a colored part other than a logo mark or a background mark, such processed image data is outputted that chromatic pixels of the logo mark or the background mark have solely been converted into achromatic pixels. That is, a color manuscript is appropriately determined as a color manuscript and, still, pixels intrinsically not requiring color output are outputted as achromatic pixels. By virtue of this, even for a manuscript requiring color output, color output is performed in such a manner that the pixels of a logo mark, a background mark, or the like not requiring color output are achromatized. Further, the color information determination is performed on a pixel basis using the chromatic image data. Thus, for example, even in a case of a manuscript in which an image that requires color output overlaps with a logo mark or a background mark, the logo mark or the background mark is exactly achromatized on a pixel basis. That is, unnecessary color output is restricted on a pixel basis. This reduces image area, that is, the number of pixels, of color output, and hence reduces the amount of output image data.

An image processing apparatus according to the present invention is characterized by further comprising receiving means for receiving specification of a region of the chromatic image, wherein the determining means determines whether color information of pixels of the read-out image data in the specified region received by the receiving means corresponds to the color information of the pixels of the chromatic image data.

In the image processing apparatus according to the present invention, the receiving means receives specification of a region of chromatic image in chromatic image data from a user. Then, the determining means performs on a pixel basis the determination whether color information of pixels of the read-out image data in the specified region received by the receiving means corresponds to the color information of the pixels of the chromatic image data. This avoids the necessity that the determination of color information should be performed for the entire pixels of the read-out image data, and hence reduces the time necessary for the determination whether the color information correspond to each other in both pixels of the read-out image data and the chromatic image data.

An image processing apparatus according to the present invention is characterized by further comprising difference determining means for determining whether a difference between the color information of the pixels of the read-out image data and the color information of the pixels of the chromatic image data falls within a predetermined range, wherein when the difference determining means determines that the difference falls within the predetermined range, said processing means converts the pixels of the read-out image data into achromatic pixels.

In the image processing apparatus according to the present invention, the difference determining means performs on a pixel basis the determination whether the difference between the color information of the pixels of the read-out image data and the color information of the pixels of the chromatic image data falls within a predetermined range. Then, when the difference determining means determines that the difference falls within the predetermined range, the processing means converts, into achromatic pixels, chromatic pixels of the read-out image data the color information of which falls within the predetermined difference range. By virtue of this, even when a difference arises in the color information of the pixels of the read-out image data relative to the actual color of the image of the manuscript, conversion of the color information into achromatic one is performed flexibly in such a manner that the read-out image data is considered as corresponding to the color information of the pixels of the chromatic image data.

An image processing apparatus according to the present invention is characterized in that said chromatic image data further includes a positioning mark for establishing alignment with the read-out image data, and that the image processing apparatus further comprises: positioning mark extracting means for extracting a positioning mark from read-out image data generated by the reading means reading the manuscript provided with the positioning mark; and alignment means for establishing alignment between the positioning mark extracted by the positioning mark extracting means and the positioning mark of the chromatic image data, wherein after the alignment between both positioning marks performed by the alignment means, the processing means deletes the positioning mark of the read-out image data.

In the image processing apparatus according to the present invention, a positioning mark (for example, a “+” mark) is added to the chromatic image data, for example, at any one of the four corners, while the same positioning mark as the positioning mark of the chromatic image data is added also to the manuscript at a corresponding position. Then, when the reading means reads the manuscript, read-out image data provided with a positioning mark is generated. As such, a positioning mark is added to the manuscript in advance, while the positioning mark extracting means extracts the positioning mark from the read-out image data. Then, the alignment means establishes alignment between the positioning mark extracted by the positioning mark extracting means and the positioning mark of the chromatic image data. In some cases, a manuscript is read in a deviated or rotated manner. However, according to the image processing apparatus of the present invention, the determination whether the color information corresponds to each other in both pixels of the read-out image data and the chromatic image data or alternatively the determination whether the difference falls within a predetermined range is performed regardless of the shift or rotation described here, in a state that the read-out image data and the chromatic image data are appropriately aligned with each other. Further, after the alignment between both positioning marks performed by the alignment means, the processing means deletes the positioning mark of the read-out image data. Thus, intrinsically unintended output of the positioning mark is prevented in conformity with intention.

An image processing apparatus according to the present invention is characterized in that the chromatic image data is read-out image data generated by the reading means reading the manuscript provided with a chromatic image.

In the image processing apparatus according to the present invention, the reading means reads a manuscript provided with at least a chromatic image among a chromatic image and a positioning mark, and thereby generates chromatic image data easily.

An image processing apparatus according to the present invention is characterized in that the reading means can successively read a plurality of manuscript sheets.

In the image processing apparatus according to the present invention, the reading means employs, for example, an automatic document feeder (ADF) for automatically and successively feeding a plurality of manuscript sheets having been set thereon, and thereby reading a plurality of manuscript sheets successively. This remarkably improves the working efficiency in the reading of a plurality of manuscript sheets in comparison with the case that the manuscript sheets are read one by one.

An image processing apparatus according to the present invention is characterized by further comprising read-out image data storing means for storing one or a plurality of the read-out image data pieces.

In the image processing apparatus according to the present invention, the read-out image data storing means is provided for storing one or a plurality of the read-out image data. Thus, even when a plurality of manuscript sheets are to be read, reading operation is achieved by a single action. This improves the working efficiency.

An image processing apparatus according to the present invention is characterized by further comprising acquiring means for acquiring image data, chromatic image data, and a specified region transmitted from an external apparatus via a network, wherein the processing means further processes the image data acquired by the acquiring means.

In the image processing apparatus according to the present invention, the acquiring means acquires the image data, the chromatic image data, and the specified region transmitted from an external apparatus via a network. Then, the processing means processes the image data acquired by the acquiring means in a manner similar to the processing of the read-out image data. By virtue of this, the image processing apparatus of the present invention can be employed not only as a scanner apparatus but also as a facsimile machine (transmitting side). This increases the universality of the apparatus.

An image processing apparatus according to the present invention is characterized by further comprising: chromatic image data storing means for storing one or a plurality of the chromatic image data pieces; and chromatic image data selecting means for selecting one or a plurality of the chromatic image data pieces stored in the chromatic image data storing means.

In the image processing apparatus according to the present invention, the chromatic image data storing means stores one or a plurality of the chromatic image data pieces (chromatic image data of the read-out image data generated by the reading means reading the manuscript and/or chromatic image data acquired by the acquiring means). Then, the chromatic image data selecting means selects one or a plurality of the chromatic image data pieces stored in the chromatic image data storing means. By virtue of this, when the operation of storing chromatic image data into the chromatic image data storing means is performed merely once, chromatic image data corresponding to various manuscripts or alternatively a plurality of chromatic image data pieces corresponding to a single manuscript can be selected easily and, further, can be repeated any number of times.

An image processing apparatus according to the present invention is characterized in that: the chromatic image data storing means stores the chromatic image data in correspondence to a chromatic image data identification code assigned to the chromatic image data; the image processing apparatus further comprises chromatic image data identification code extracting means for extracting a chromatic image data identification code from the read-out image data generated by the reading means reading the manuscript provided with the chromatic image data identification code; on the basis of the chromatic image data identification code extracted by the chromatic image data identification code extracting means, the chromatic image data selecting means selects one or a plurality of the chromatic image data pieces stored in the chromatic image data storing means; and after the selection of the chromatic image data performed by the chromatic image data selecting means, the processing means deletes the chromatic image data identification code of the read-out image data.

In the image processing apparatus according to the present invention, the chromatic image data storing means stores chromatic image data in correspondence to a chromatic image data identification code (such as a bar code and a symbol). Then, in the manuscript, the same chromatic image data identification code as the above-mentioned chromatic image data identification code is added at an appropriate position (for example, in a periphery of the manuscript). By virtue of this, when the reading means reads the manuscript, read-out image data provided with the chromatic image data identification code is generated. As such, a chromatic image data identification code is added to the manuscript in advance, while the chromatic image data identification code extracting means extracts the chromatic image data identification code from the read-out image data. Then, on the basis of the chromatic image data identification code extracted by the chromatic image data identification code extracting means, the chromatic image data selecting means selects one or a plurality of the chromatic image data pieces stored in the chromatic image data storing means. By virtue of this, when reading operation for a manuscript provided with a chromatic image data identification code is merely performed, chromatic image data stored in the chromatic image data storing means is selected automatically. Thus, the selection of chromatic image data performed by a user becomes unnecessary so that operability is improved. Further, after the selection of the chromatic image data performed by the chromatic image data selecting means, the processing means deletes the chromatic image data identification code of the read-out image data, so that intrinsically unintended output of the chromatic image data identification code is prevented in conformity with intention.

An image processing apparatus according to the present invention is characterized by further comprising manuscript determining means for determining whether any manuscript to be read is present, wherein: when the manuscript determining means determines as present, the chromatic image data is read-out image data generated by the reading means reading a first manuscript sheet; after the reading means reads the first manuscript sheet, the manuscript determining means determines whether any manuscript still remains; and when the manuscript determining means determines as remaining, the processing means processes read-out image data generated by the reading means reading the remaining manuscript.

In the image processing apparatus according to the present invention, the manuscript determining means determines whether any manuscript to be read, that is, any manuscript having been set, is present. When the manuscript determining means determines as present, the reading means reads the first manuscript sheet having been set, and thereby generates read-out image data. This data is set to be chromatic image data. Then, the manuscript determining means determines whether any further remaining manuscript, that is, the second or subsequent manuscript sheet, is still present. When the manuscript determining means determines as still present, the reading means reads all of the second and subsequent manuscript sheets, and thereby generating read-out image data. Then, the processing means processes the read-out image data. Accordingly, in a case that two or more manuscript sheets are to be read, when the first manuscript sheet is set to be a manuscript sheet provided solely with a chromatic image the color output of which is to be restricted, the read-out image data of the first manuscript sheet automatically becomes chromatic image data. This avoids the necessity of operation of storing chromatic image data into the chromatic image data storing means in advance. Further, serial operation of successively reading a plurality of manuscript sheets is sufficient, and hence avoids the necessity of selection of the chromatic image data corresponding to the manuscript performed by the chromatic image data selecting means. This improves the operability.

An image processing apparatus according to the present invention is characterized by further comprising: specified region storing means for storing one or a plurality of the specified regions; and specified region selecting means for selecting one or a plurality of the specified regions stored in the specified region storing means.

In the image processing apparatus according to the present invention, the specified region storing means stores one or a plurality of specified regions (specified regions received by the receiving means and/or specified regions acquired by the acquiring means). Then, the specified region selecting means selects one or a plurality of the specified regions stored in the specified region storing means. By virtue of this, when the operation of storing specified regions into the specified region storing means is performed merely once, a specified region corresponding to various manuscripts or alternatively a plurality of specified regions corresponding to a single manuscript can be selected easily and, further, can be repeated any number of times.

An image processing apparatus according to the present invention is characterized in that: the specified region storing means stores the specified region in correspondence to a specified region identification code assigned to the specified region; the image processing apparatus further comprises specified region identification code extracting means for extracting a specified region identification code from the read-out image data generated by the reading means reading the manuscript provided with the specified region identification code; on the basis of the specified region identification code extracted by the specified region identification code extracting means, the specified region selecting means selects one or a plurality of the specified regions stored in the specified region storing means; and after the selection of the specified region performed by the specified region selecting means, the processing means deletes the specified region identification code of the read-out image data.

In the image processing apparatus according to the present invention, the specified region storing means stores the specified region in correspondence to a specified region identification code (such as a bar code and a symbol). Then, the same specified region identification code as the above-mentioned specified region identification code is added also to the manuscript at an appropriate position (for example, in a periphery of the manuscript). By virtue of this, when the reading means reads the manuscript, read-out image data provided with the chromatic image data identification code is generated. As such, a specified region identification code is added to the manuscript in advance, while the specified region identification code extracting means extracts the specified region identification code from the read-out image data. Then, on the basis of the specified region identification code extracted by the specified region identification code extracting means, the specified region selecting means selects one or a plurality of the specified regions stored in the specified region storing means. By virtue of this, when the operation of reading a manuscript provided with a specified region identification code is merely performed, a specified region stored in the specified region storing means is selected automatically, so that the selection of a specified region performed by a user becomes unnecessary so that operability is improved. Further, after the selection of the specified region performed by the specified region selecting means, the processing means deletes the specified region identification code of the read-out image data, so that intrinsically unintended output of the specified region identification code is prevented in conformity with intention.

An image forming apparatus according to the present invention is characterized by comprising: an image processing apparatus described above; and image forming means for performing image formation on a recording medium on the basis of the processed image data processed by the processing means of the image processing apparatus.

The image forming apparatus according to the present invention comprises an image processing apparatus described above, while the image forming means performs image formation of the processed image data processed by the processing means, onto a recording medium. Thus, as for a manuscript (partly colored manuscript) in which a logo mark or a background mark is solely in color so that color output is not required, the entire processed image data has already been achromatized (into monochrome). Thus, image formation is entirely performed in an achromatic (monochrome) mode. Further, as for a manuscript (color manuscript) provided with a colored part other than a logo mark or a background mark so that color output is required, the processed image data is not entirely chromatic (colored) while the logo mark or the background mark is achromatized. Thus, a part the image formation of which is to be performed in a chromatic (color) mode is restricted. Further, also for a manuscript in which an image that requires color output overlaps with a colored logo mark or background mark, the image is not achromatized while the pixels of the logo mark or the background mark are solely achromatized in the processed image data. Thus, a part the image formation of which is to be performed in a chromatic (color) mode is restricted. By virtue of this, even when image formation is performed in a chromatic (color) mode, consumable supplies such as color toner and color ink necessary for color image formation are prevented from being consumed uselessly, so that image formation cost is reduced while image formation speed is improved.

According to the present invention, specification of an arbitrary image region of a manuscript is received. Then, it is determined whether pixels of the read-out image data in a region other than the received specified region are achromatic. Then, only when determined as achromatic, chromatic pixels of the read-out image data in the specified region are converted into achromatic pixels. Thus, when a user specifies as an image region the region of a logo mark or a background mark, a manuscript (partly colored manuscript) in which a logo mark or a background mark is solely in color so that color output is intrinsically not required is determined as a monochrome manuscript. This restricts overall color output of the read-out image data, hence increases achromatic output, and thereby reduces the amount of output image data. Further, the reduction in the amount of output image data accelerates the data transmission speed to an output destination device. Furthermore, in the output destination device, even when image formation is performed in a chromatic (color) mode, consumable supplies such as color toner and color ink necessary for color image formation are prevented from being consumed uselessly, so that image formation cost is reduced while image formation speed is improved.

Further, according to the present invention, specification of an arbitrary image region of the manuscript is received. Then, chromatic pixels of the read-out image data in the received specified region are converted into achromatic pixels. Thus, when a user specifies as an image region the region of a logo mark or a background mark, a manuscript (partly colored manuscript) in which a logo mark or a background mark is solely in color so that color output is not required is determined as a monochrome manuscript. This restricts overall color output of the read-out image data, hence increases achromatic output, and thereby reduces the amount of output image data. Further, a manuscript (color manuscript) provided with a colored part other than a logo mark or a background mark so that color output is required is appropriately determined as a color manuscript. Still, pixels intrinsically not requiring color output are solely converted into achromatic pixels so that the image area, that is, the number of pixels, of the color output is reduced. This reduces the amount of output image data. Further, the reduction in the amount of output image data accelerates the data transmission speed to an output destination device. Furthermore, in the output destination device, even when image formation is performed in a chromatic (color) mode, consumable supplies such as color toner and color ink necessary for color image formation are prevented from being consumed uselessly, so that image formation cost is reduced while image formation speed is improved.

Further, according to the present invention, the determination is performed on a pixel basis whether the color information of the pixels of the read-out image data corresponds to the color information of the pixels of the chromatic image data generated by registering as data the chromatic image of a part such as a logo mark and a background mark not requiring color output in particular. Then, only when the color information corresponds to each other in both pixels, chromatic pixels of the corresponding read-out image data are converted into achromatic pixels. Thus, even when the image not requiring color output has a complicated shape, the pixels to be achromatized can be specified clearly. That is, even a manuscript in which an image that requires color output overlaps with a colored logo mark or background mark is appropriately determined as a color manuscript. Still, pixels intrinsically not requiring color output are solely converted into achromatic pixels exactly on a pixel basis so that the image area, that is, the number of pixels, of the color output is reduced. This reduces the amount of output image data. Further, a manuscript (partly colored manuscript) in which a logo mark or a background mark is solely in color so that color output is not required is determined as a monochrome manuscript. This restricts overall color output of the read-out image data, hence increases achromatic output, and thereby reduces the amount of output image data. Further, the reduction in the amount of output image data accelerates the data transmission speed to an output destination device. Furthermore, in the output destination device, even when image formation is performed in a chromatic (color) mode, consumable supplies such as color toner and color ink necessary for color image formation are prevented from being consumed uselessly, so that image formation cost is reduced while image formation speed is improved.

Further, according to the present invention, the determination of color information is performed not for the entire pixels of the read-out image data, but for a specified region which is specified in the chromatic image of chromatic image data. This reduces the time necessary for the determination whether the color information corresponds to each other in both pixels of the read-out image data and the chromatic image data.

Further, according to the present invention, when the difference between the color information of the pixels of the read-out image data and the color information of the pixels of the chromatic image data falls within a predetermined range, chromatic pixels of the read-out image data the color information of which falls within the predetermined difference range are converted into achromatic pixels. Thus, even when a difference arises in the color information of the pixels of the read-out image data relative to the actual color of the image of the manuscript, conversion of the color information into achromatic one is performed flexibly in such a manner that the read-out image data is considered as corresponding to the color information of the pixels of the chromatic image data.

Further, according to the present invention, even in a case where a manuscript is read in a deviated or rotated manner, the read-out image data and the chromatic image data are aligned on the basis of the positioning marks provided in both image data pieces. Accordingly, the determination whether the color information corresponds to each other in both pixels of the read-out image data and the chromatic image data or alternatively the determination whether the difference falls within a predetermined range is performed regardless of the shift or rotation described here, in a state that both image data pieces are appropriately aligned to each other. Further, after the alignment between both positioning marks performed by the alignment means, the positioning mark of the read-out image data is deleted. Thus, intrinsically unintended output of the positioning mark is prevented in conformity with intention.

Further, according to the present invention, a manuscript provided with a chromatic image is read. Thus, chromatic image data is generated easily.

Further, according to the present invention, a plurality of manuscript sheets are read successively. This remarkably improves the working efficiency in the reading in comparison with the case where the manuscript sheets are read one by one.

Further, according to the present invention, read-out image data storing means is provided for storing one or a plurality of read-out image data. Thus, even when a plurality of manuscript sheets are to be read, reading operation is achieved by a single action. This improves the working efficiency.

Further, according to the present invention, image data, chromatic image data, and a specified region transmitted from an external apparatus via a network can be acquired through the acquiring means. Further, the acquired image data is processed similarly to the processing of the read-out image data. By virtue of this, the image processing apparatus of the present invention can be employed not only as a scanner apparatus but also as a facsimile machine (transmitting side). This increases the universality of the apparatus.

Further, according to the present invention, when the operation of storing chromatic image data into the chromatic image data storing means is performed merely once, chromatic image data corresponding to various manuscripts or alternatively a plurality of chromatic image data pieces corresponding to a single manuscript can be selected easily and, further, can be repeated any number of times.

Further, according to the present invention, when reading operation for a manuscript provided with a chromatic image data identification code is merely performed, chromatic image data stored in the chromatic image data storing means is automatically selected on the basis of the chromatic image data identification code extracted from the read-out image data. Thus, the selection of chromatic image data performed by a user becomes unnecessary so that operability is improved. Further, after the selection of the chromatic image data performed by the chromatic image data selecting means, the chromatic image data identification code of the read-out image data is deleted, so that intrinsically unintended output of the chromatic image data identification code is prevented in conformity with intention.

Further, according to the present invention, in a case where two or more manuscript sheets are to be read, when the first manuscript sheet is set to be a manuscript provided solely with a chromatic image the color output of which is to be restricted, the read-out image data of the first manuscript sheet automatically becomes chromatic image data. This avoids the necessity of operation of storing chromatic image data into the chromatic image data storing means in advance. By virtue of this, serial operation of successively reading a plurality of manuscript sheets is sufficient, and hence avoids the necessity of selection of the chromatic image data corresponding to the manuscript performed by the chromatic image data selecting means. This improves the operability.

Further, according to the present invention, when the operation of storing specified regions into the specified region storing means is performed merely once, a specified region corresponding to various manuscripts or alternatively a plurality of specified regions corresponding to a single manuscript can be selected easily and, further, can be repeated any number of times.

Further, according to the present invention, when reading operation for a manuscript provided with a chromatic image data identification code is merely performed, chromatic image data stored in the chromatic image data storing means is automatically selected on the basis of the chromatic image data identification code extracted from the read-out image data. Thus, the selection of chromatic image data performed by a user becomes unnecessary so that operability is improved. Further, after the selection of the specified region performed by the specified region selecting means, the specified region identification code of the read-out image data is deleted, so that intrinsically unintended output of the specified region identification code is prevented in conformity with intention.

Further, according to the present invention, the above-mentioned image processing apparatus is provided. Thus, as for a manuscript (partly colored manuscript) in which a logo mark or a background mark is solely in color so that color output is not required, the entire processed image data has already been achromatized (into monochrome). Thus, image formation is entirely performed in an achromatic (monochrome) mode. Further, as for a manuscript (color manuscript) provided with a colored part other than a logo mark or a background mark so that color output is required, the processed image data is not entirely chromatic (colored) while the logo mark or the background mark is achromatized. Thus, a part the image formation of which is to be performed in a chromatic (color) mode is restricted. Further, also for a manuscript in which an image that requires color output overlaps with a logo mark or a background mark, the image is not achromatized while the pixels of the logo mark or the background mark are solely achromatized in the processed image data. Thus, a part the image formation of which is to be performed in a chromatic (color) mode is restricted. By virtue of this, even when image formation is performed in a chromatic (color) mode, consumable supplies such as color toner and color ink necessary for color image formation are prevented from being consumed uselessly, so that image formation cost is reduced while image formation speed is improved.

### BRIEF DESCRIPTION OF THE DRAWINGS

FIG. 1 is a block diagram showing the configuration of an image processing apparatus in a case where the present invention is applied to a multi-functional machine having a scanner function and a facsimile function;

FIG. 2 is a diagram showing the relation between specified regions/read-out image data/output image data for the determination of color manuscript/monochrome manuscript according to Embodiment 1 of the present invention;

FIG. 3 is a diagram showing the relation between specified regions/read-out image data/output image data for the determination of color manuscript/monochrome manuscript according to Embodiment 1 of the present invention;

FIG. 4 is a diagram describing coordinate data of specified regions each for specifying a region not requiring color output in the read-out image data of FIGS. 2 and 3;

FIG. 5 is a flow chart showing a procedure of read-out image data processing and processed image data output performed by a control section of an image processing apparatus according to Embodiment 1 of the present invention;

FIG. 6 is a diagram showing the relation between specified regions/read-out image data/output image data for the determination of color manuscript/monochrome manuscript according to Embodiment 2 of the present invention;

FIG. 7 is a diagram showing the relation between specified regions/read-out image data/output image data for the determination of color manuscript/monochrome manuscript according to Embodiment 2 of the present invention;

FIG. 8 is a flow chart showing a procedure of read-out image data processing and processed image data output performed by a control section of an image processing apparatus according to Embodiment 2 of the present invention;

FIG. 9 is a flow chart showing a procedure of manuscript read processing performed by a control section of an image processing apparatus according to Embodiment 2 of the present invention;

FIG. 10 is a flow chart showing a procedure of output processing performed by a control section of an image processing apparatus according to Embodiment 2 of the present invention;

FIG. 11 is a diagram showing the relation between chromatic image data/read-out image data/output image data for the determination of color manuscript/monochrome manuscript according to Embodiment 3 of the present invention;

FIG. 12 is a diagram showing the relation between chromatic image data/read-out image data/output image data for the determination of color manuscript/monochrome manuscript according to Embodiment 3 of the present invention;

FIG. 13 is a flow chart showing a procedure of registration of chromatic image data performed by a control section of an image processing apparatus according to Embodiment 3 of the present invention;

FIG. 14 is a diagram showing a state that chromatic image data is stored in a chromatic image memory;

FIG. 15 is a flow chart showing a procedure of read-out image data processing and processed image data output performed by a control section of an image processing apparatus according to Embodiment 3 of the present invention;

FIG. 16 is a flow chart showing a procedure of image processing performed by a control section of an image processing apparatus according to Embodiment 3 of the present invention;

FIG. 17 is a flow chart showing a procedure of color information conversion processing performed by a control section of an image processing apparatus according to Embodiment 3 of the present invention;

FIG. 18 is a diagram showing the relation between chromatic image data+specified regions/read-out image data/output image data for the determination of color manuscript/monochrome manuscript according to Embodiment 4 of the present invention;

FIG. 19 is a diagram showing the relation between chromatic image data+specified regions/read-out image data/output image data for the determination of color manuscript/monochrome manuscript according to Embodiment 4 of the present invention;

FIG. 20 is a flow chart showing a procedure of registration of chromatic image data and specified regions performed by a control section of an image processing apparatus according to Embodiment 4 of the present invention;

FIG. 21 is a diagram showing a state that chromatic image data and specified regions are stored in a chromatic image memory and a specified region memory;

FIG. 22 is a flow chart showing a procedure of read-out image data processing and processed image data output performed by a control section of an image processing apparatus according to Embodiment 4 of the present invention;

FIG. 23 is a flow chart showing a procedure of image processing performed by a control section of an image processing apparatus according to Embodiment 4 of the present invention;

FIG. 24 is a diagram showing the relation between chromatic image data+positioning marks/read-out image data/output image data for the determination of color manuscript/monochrome manuscript according to Embodiment 5 of the present invention;

FIG. 25 is a diagram showing the relation between chromatic image data+positioning marks/read-out image data/output image data for the determination of color manuscript/monochrome manuscript according to Embodiment 5 of the present invention;

FIG. 26 is a flow chart showing a procedure of read-out image data processing and processed image data output performed by a control section of an image processing apparatus according to Embodiment 5 of the present invention;

FIG. 27 is a diagram showing a state that color information difference allowable range data is stored in a color information difference allowable range table memory;

FIG. 28 is a flow chart showing a procedure of color information conversion processing performed by a control section of an image processing apparatus according to Embodiment 6 of the present invention;

FIG. 29 is a diagram describing the order of reading manuscript sheets according to Embodiment 7 of the present invention;

FIG. 30 is a flow chart showing a procedure of read-out image data processing and processed image data output performed by a control section of an image processing apparatus according to Embodiment 7 of the present invention;

FIG. 31 is a diagram showing the relation between chromatic image data+specified regions/read-out image data/output image data for the determination of color manuscript/monochrome manuscript according to Embodiment 8 of the present invention;

FIG. 32 is a diagram showing the relation between chromatic image data+specified regions/read-out image data/output image data for the determination of color manuscript/monochrome manuscript according to Embodiment 8 of the present invention;

FIG. 33 is a flow chart showing a procedure of read-out image data processing and processed image data output performed by a control section of an image processing apparatus according to Embodiment 8 of the present invention; and

FIG. 34 is a block diagram showing the configuration of an image forming apparatus according to Embodiment 9 in a case where the present invention is applied to a multi-functional machine having a scanner function, a copy function, a print function, and a facsimile function.

### EXPLANATION OF REFERENCE NUMBERS

1 Control section
2 Bus
3 ROM
4 RAM
5 Display section
6 Operation section
7 Interface section
8 Automatic document feeder
9 Reading section
10 Read-out image memory
11 Copied image memory
12 Chromatic image memory
13 Specified region memory
14 Color information difference allowable range table memory
15 Image forming section

### BEST MODE FOR IMPLEMENTING THE INVENTION

The present invention is described below in detail with reference to the drawings that illustrate embodiments.

(Embodiment 1)

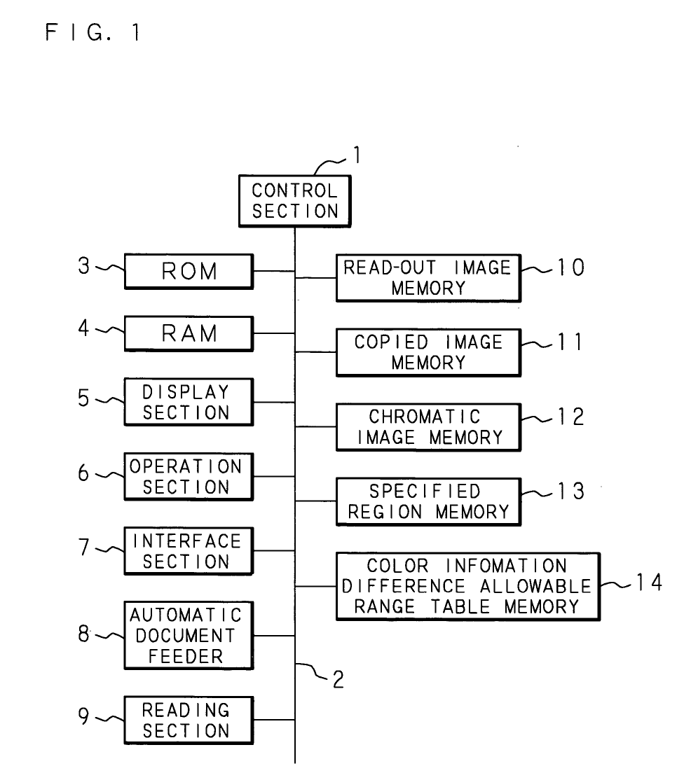

FIG. 1 is a block diagram showing the configuration of an image processing apparatus in a case where the present invention is applied to a multi-functional machine having a scanner function and a facsimile function. In the figure, numeral 1 indicates a control section for controlling the entire apparatus, which is composed of an MPU. The control section 1 is connected through a bus 2 to a ROM 3, a RAM 4, a display section 5, an operation section 6, an interface section 7, an automatic document feeder 8, a reading section 9, a read-out image memory 10, a copied image memory 11, a chromatic image memory 12, a specified region memory 13, and a color information difference allowable range table memory 14.

The ROM 3 stores a control program and various kinds of data for the operation of the image processing apparatus. The control section 1 controls the operation of each part of the image processing apparatus according to the control program stored in the ROM 3, thereby performing processing of read-out image data, and further performing output control for processed image data.

On the basis of the control performed by the control section 1, the display section 5 displays the operating state of the image processing apparatus and various menus stored in the ROM 3. The operation section 6 comprises function keys, a start key, and a ten-key pad (not shown) used when a user operates the image processing apparatus on the basis of the contents of display of the display section 5. Various kinds of instruction information received from a user through the operation section 6 is stored in the RAM 4 on the basis of the control performed by the control section 1. Here, the display section 5 and the operation section 6 may be integrally composed of a touch panel.

The interface section 7 links the image processing apparatus of the present invention to an external apparatus (not shown), and thereby permitting transmission and reception of data between these apparatuses. The interface section 7 is constructed from a USB (Universal Serial Bus), a SCSI (Small Computer System Interface), an IEEE (Institute of Electrical and Electronics Engineers) 1284, an IEEE 1394, or an Ethernet (registered trademark) such as 10/100 BASE-TX, and a modem.

The automatic document feeder 8 automatically feeds mounted manuscript sheets one by one to the reading section 9 on the basis of the control performed by the control section 1.

The reading section 9 comprises: a light source for projecting light onto a manuscript; a CCD (Charge Coupled Device) the light receiving section of which is arranged in a line shape (in the main scanning direction); and an AD converter (not shown). The light source and the CCD are constructed integrally. The light receiving section of the CCD is covered by color filters arranged in a regular order. Thus, from the reflected light reflected from the manuscript to the light receiving section, the CCD detects the brightness of the color information of R (Red), G (Green), and B (Blue) of the manuscript via the color filters, and then outputs as a voltage value the amount of charge corresponding to the brightness (luminosity) of each detected light. Then, the AD converter converts into a digital signal the voltage value outputted by the CCD, so that a digital signal for one line is obtained. On the basis of the control performed by the control section 1, the reading section 9 moves (sub-scans) the CCD in a sub-scanning direction (a direction intersecting with the main scanning direction). When such serial operation is repeated, digital read-out image data for one page of the manuscript is generated.

The read-out image data of the manuscript generated by the reading section 9 is stored into the read-out image memory 10 on the basis of the control performed by the control section 1. Further, the read-out image data stored in the read-out image memory 10 is further stored (copied) into the copied image memory 11 on the basis of the control performed by the control section 1.

On the basis of the control performed by the control section 1, chromatic image data generated by registering a chromatic image as data is stored into the chromatic image memory 12 when the reading section 9 reads a manuscript provided with a chromatic image and then generates the data or alternatively when the data is received from a computer (external apparatus) via the interface section 7.

On the basis of the control performed by the control section 1, coordinate data of a rectangle for specifying an image region such as a logo mark or a background mark in a manuscript or a chromatic image region of chromatic image data is stored into the specified region memory 13 when the data is inputted by a user through the operation section 6 or alternatively when the data is received from a computer (external apparatus) via the interface section 7.

On the basis of the control performed by the control section 1, color information difference allowable range data used in the determination of the color information of the images of the read-out image data and the chromatic image data is stored into the color information difference allowable range table memory 14 when the data is inputted by a user through the operation section 6 or alternatively when the data is received from a computer (external apparatus) via the interface section 7.

On the basis of the control performed by the control section 1, the image processing apparatus of the present invention outputs, that is, transmits, image processing result for read-out image data generated by the reading section 9 reading a manuscript, to a computer or another facsimile machine (external apparatus) via the interface section 7. Further, the image processing apparatus receives various kinds of data from the computer.

In the image processing apparatus having the above-mentioned configuration, a processing method and an output method for read-out image data are described below in which as for the read-out image data of a manuscript, the read-out manuscript is determined whether a color manuscript or a monochrome manuscript in a state that a part not requiring color output is removed from the color determination, and in which the processing and the output are then performed on the basis of the determination result. Here, Embodiment 1 is described for the case that the manuscript to be read is a presentation sheet.

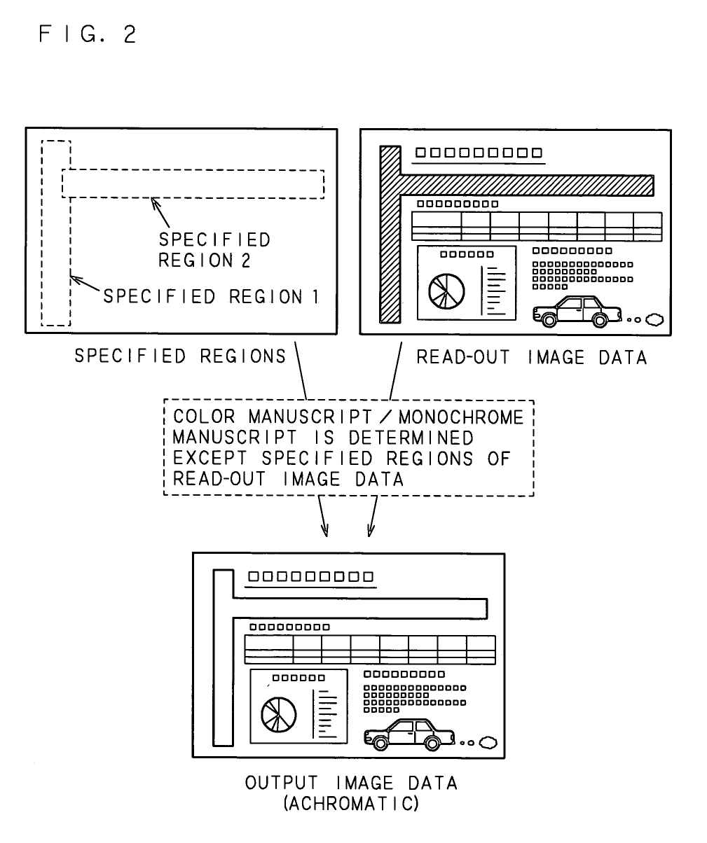

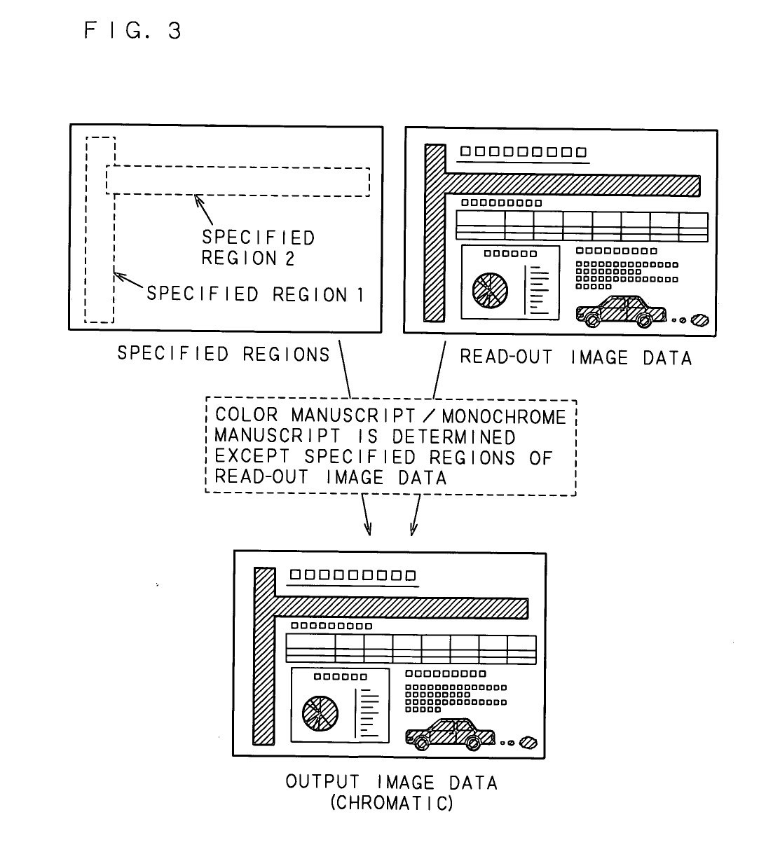

FIGS. 2 and 3 are diagrams showing the relation between specified regions/read-out image data/output image data for the determination of color manuscript/monochrome manuscript according to Embodiment 1 of the present invention. Here, a colored (chromatic) part is indicated as a shaded region in the figure (this convention holds also for the following description).

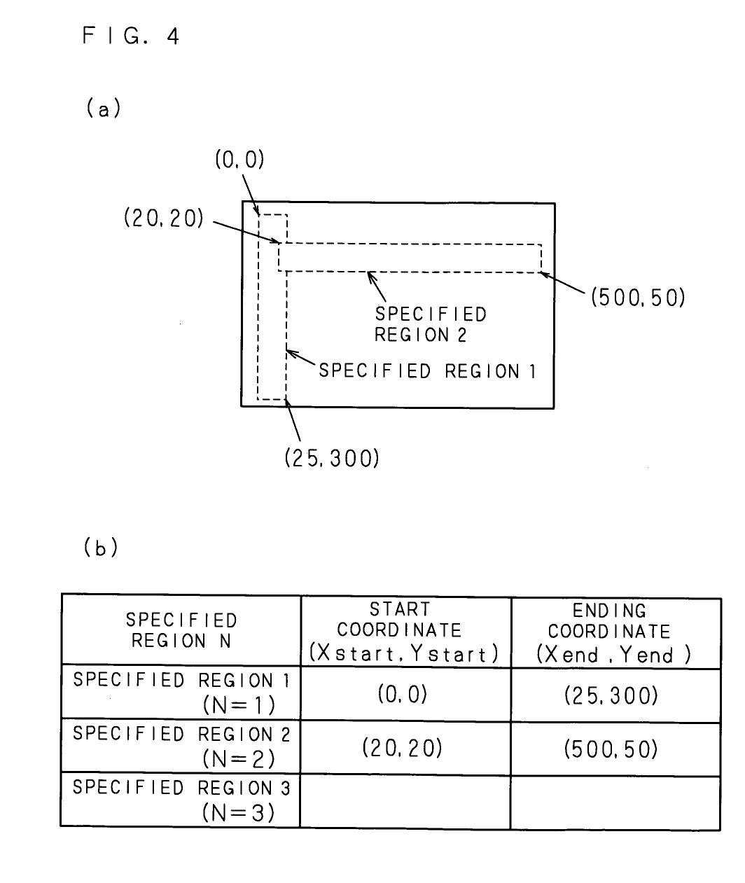

FIG. 4 is a diagram describing coordinate data of specified regions each for specifying a region not requiring color output in the read-out image data of FIGS. 2 and 3. Part (a) shows coordinates in the read-out image data, while part (b) shows a state that the coordinate data of part (a) is stored in the specified region memory 13. As shown in FIG. 4, the specified region is stored into the specified region memory 13 as coordinate data of a rectangle defined by a start coordinate (Xstart, Ystart) and an ending coordinate (Xend, Yend) in a manner corresponding to a counter N (N=1, 2) for indicating the number of specified region for each specified region, in prior to the image processing of the manuscript, when the data is inputted by a user through the operation section 6 or alternatively when the data is received from a computer (external apparatus) via the interface section 7. Here, each of (Xstart, Xend) and (Ystart, Yend) indicates a coordinate (Xcount, Ycount) each component of which is defined in the main scanning direction or the sub-scanning direction of the read-out image data (this convention holds also for the following description).

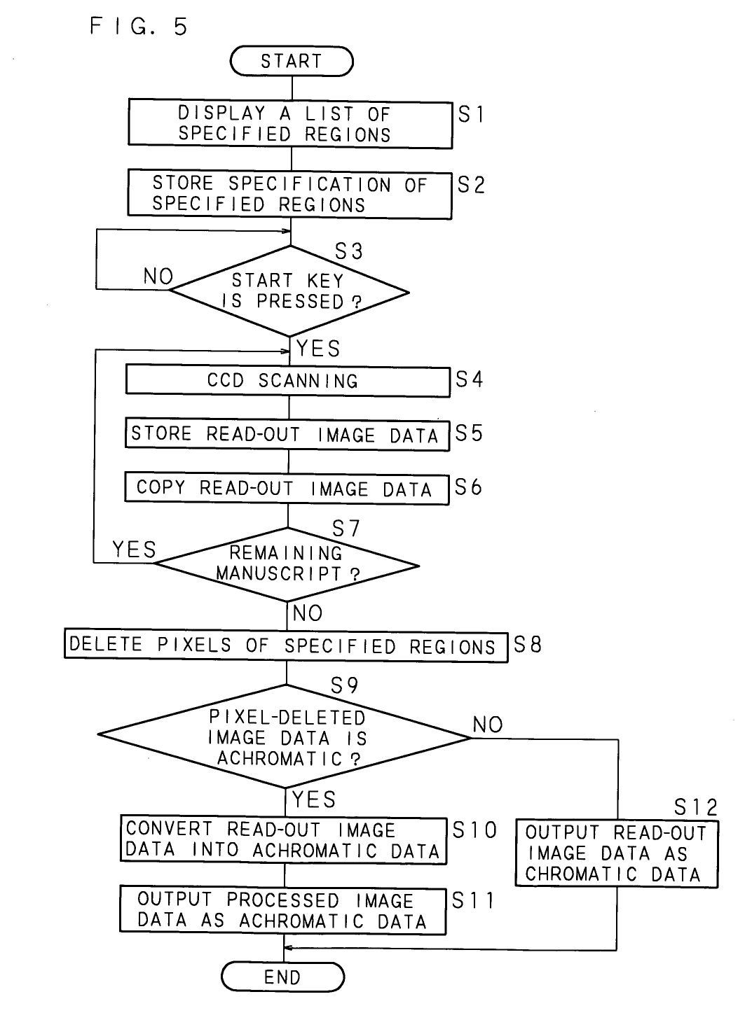

After the specified region is registered as described above, image processing of the manuscript is performed. FIG. 5 is a flow chart showing a procedure of read-out image data processing and processed image data output performed by the control section 1 of the image processing apparatus according to Embodiment 1 of the present invention.

First, the control section 1 displays on the display section 5 a list of specified regions stored in the specified region memory 13 (S1), and then stores into the RAM 4 the specification of specified regions inputted through the operation section 6 (S2). In this example, specified regions 1 and 2 (N=1, 2) shown in FIG. 4(b) are specified.

Next, the control section 1 monitors the pressing of the start key of the operation section 6 serving as the input of an instruction of read start for the manuscript (S3). When the start key of the operation section 6 is not yet pressed (S3: NO), the control section 1 continues to monitor the pressing. On the other hand, when the start key has been pressed (S3: YES), the control section 1 scans the CCD of the reading section 9 (S4), and then stores into the read-out image memory 10 the read-out image data of the manuscript fed from the automatic document feeder 8 and then read by the reading section 9 (S5). The control section 1 further copies into the copied image memory 11 the read-out image data stored in the read-out image memory 10 (S6).

Then, the control section 1 determines the presence or absence of a remaining manuscript not yet read by the reading section 9 (S7). When the presence of a manuscript not yet read is concluded (S7: YES), the procedure goes to step S4, and then the control section 1 repeats the subsequent processing. On the other hand, when the absence of a manuscript not yet read is concluded (S7: NO), with respect to the read-out image data copied into the copied image memory 11, the pixels of the specified regions specified at step S2 are deleted (S8). As such, the deletion of the pixels of the specified regions is performed onto the read-out image data copied into the copied image memory 11, and hence this does not affect the final output image data.

Next, the control section 1 determines whether the pixel-deleted image data in which the pixels of the specified regions in the copied image memory 11 are deleted is achromatic, that is, whether the data is achromatic or chromatic (S9). At step S9, when the data is determined as achromatic (S9: YES), the control section 1 determines the read-out manuscript as a monochrome manuscript, and then converts the read-out image data stored in the read-out image memory 10, into achromatic data by means of a publicly known technique (S10). Then, the control section 1 outputs as achromatic data the processed image data converted into achromatic data (S11), and then completes the processing. On the other hand, at step S9, when the data is determined as not achromatic, that is, as chromatic (S9: NO), the control section 1 determines the read-out manuscript as a color manuscript, and then outputs the read-out image data stored in the read-out image memory 10, intact as chromatic data without processing (S12), and then completes the processing.

According to the above-mentioned procedure, a manuscript in which a part (a logo mark or a background mark) not requiring color output is solely in color is determined as a monochrome manuscript, so that unnecessary color output of the read-out image data is avoided.

(Embodiment 2)

In Embodiment 2, a processing method and an output method for read-out image data are described below in which as for the read-out image data of a manuscript, a part not requiring color output is achromatized, and in which the read-out manuscript is determined whether a color manuscript or a monochrome manuscript on the basis of the achromatized manuscript so that the processing and the output are then performed on the basis of the determination result.

Here, the configuration of the image processing apparatus of Embodiment 2 is similar to that of Embodiment 1. Thus, the configuration of the image processing apparatus described in FIG. 1 is referred to herein, and its description is omitted. Further, also in the description of Embodiment 2, the manuscript to be read is a presentation sheet similarly to Embodiment 1.

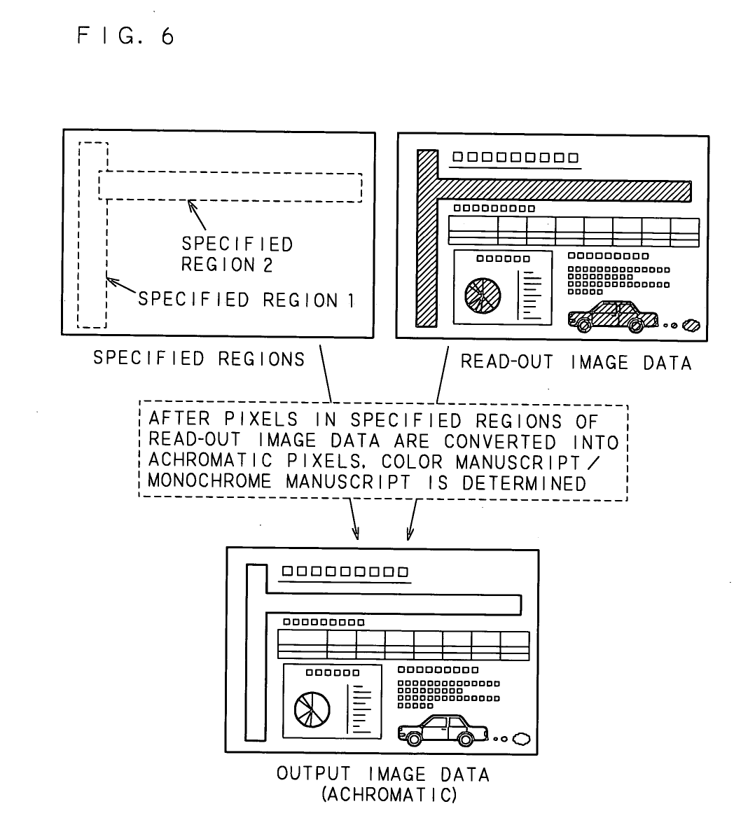

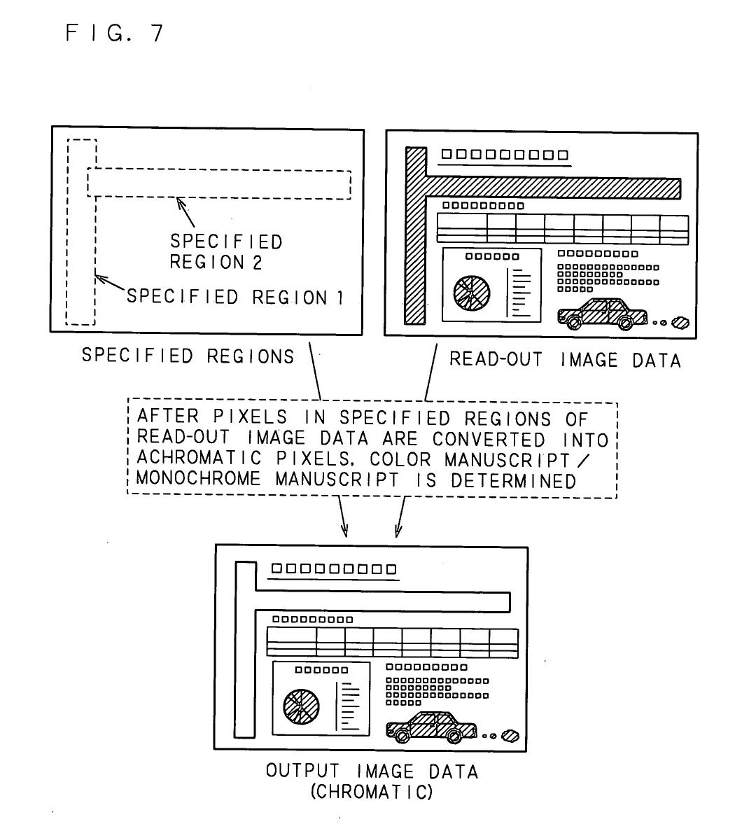

FIGS. 6 and 7 are diagrams showing the relation between specified regions/read-out image data/output image data for the determination of color manuscript/monochrome manuscript according to Embodiment 2 of the present invention. Here, specified regions each for specifying a region not requiring color output as shown in FIG s. 6 and 7 are stored into the specified region memory 13 similarly to Embodiment 1 as shown in FIG. 4 as coordinate data of a rectangle for each specified region, in prior to the image processing of the manuscript when the specification is inputted by a user through the operation section 6 or alternatively when the specification is received from a computer (external apparatus) via the interface section 7.

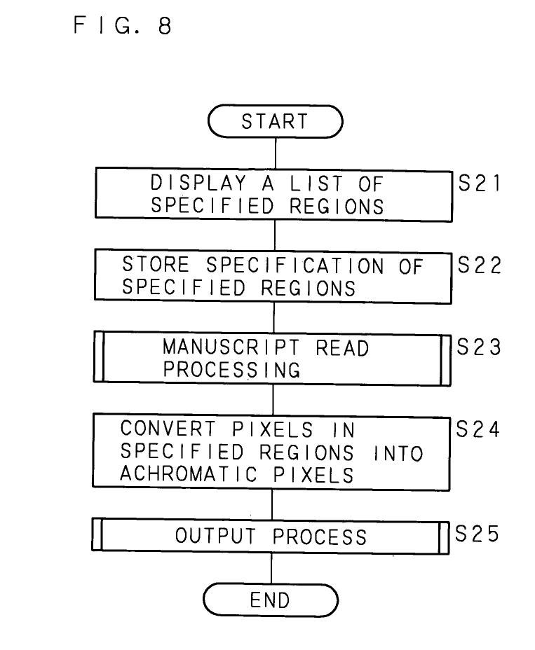

After the specified region is registered as described above, image processing of the manuscript is performed. FIG. 8 is a flow chart showing a procedure of read-out image data processing and processed image data output performed by the control section 1 of the image processing apparatus according to Embodiment 2 of the present invention.

First, the control section 1 displays on the display section 5 a list of specified regions stored in the specified region memory 13 (S21), and then stores into the RAM 4 the specification of specified regions inputted through the operation section 6 (S22). In this example, specified regions 1 and 2 (N=1, 2) shown in FIG. 4(b) are specified.

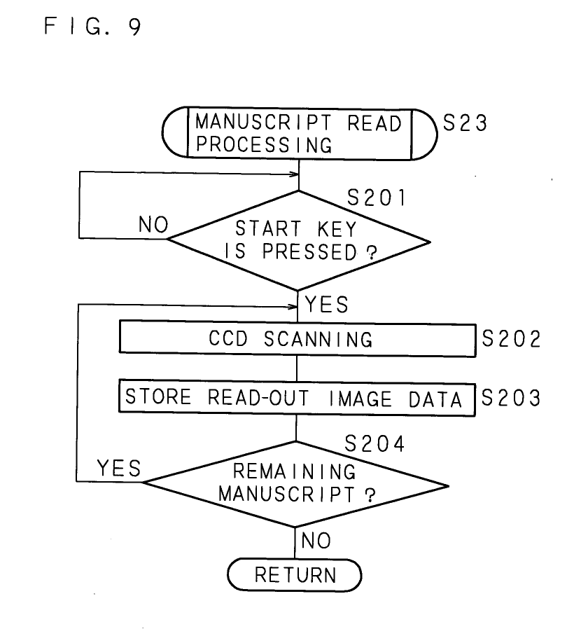

Then, the control section 1 performs manuscript read processing (S23). Described below is the manuscript read processing according to Embodiment 2 of the present invention. FIG. 9 is a flow chart showing a procedure of manuscript read processing performed by the control section 1 of the image processing apparatus. according to Embodiment 2 of the present invention, which is a subroutine included in the flow chart of FIG. 8.

First, after the processing of step S22 shown in FIG. 8, the control section 1 monitors the pressing of the start key of the operation section 6 serving as the input of an instruction of read start for the manuscript (S201). When the start key of the operation section 6 is not yet pressed (S201: NO), the control section .1 continues to monitor the pressing. On the other hand, when the start key has been pressed (S201: YES), the control section 1 scans the CCD of the reading section 9 (S202), and then stores into the read-out image memory 10 the read-out image data of the manuscript fed from the automatic document feeder 8 and then read by the reading section 9 (S203). Then, the control section 1 determines the presence or absence of a remaining manuscript not yet read by the reading section 9 (S204). When the presence of a manuscript not yet read is concluded (S204: YES), the procedure goes to step S202, and then the control section 1 repeats the subsequent processing. On the other hand, when the absence of a manuscript not yet read is concluded (S204: NO), the procedure returns to the main routine of FIG. 8.

After returning to the flow chart of FIG. 8, the control section 1 converts the pixels in the specified region specified at step S22 of the read-out image data copied into the read-out image memory 10, into achromatic pixels by means of a publicly known technique (S24).

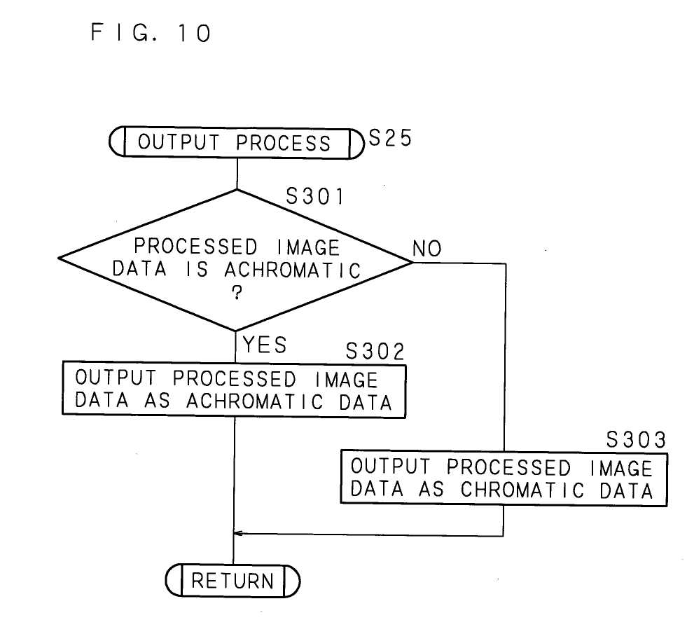

Then, the control section 1 performs the output process (S25), and then completes the processing. This output processing according to Embodiment 2 of the present invention is described below. FIG. 10 is a flow chart showing a procedure of output processing performed by the control section 1 of the image processing apparatus according to Embodiment 2 of the present invention, which is a subroutine included in the flow chart of FIG. 8.

After the processing of step S24 shown in FIG. 8, the control section 1 determines whether the processed image data stored in the read-out image memory 10 is achromatic, that is, whether the data is achromatic or chromatic (S301). At step S301, when the data is determined as achromatic (S301: YES), the control section 1 determines the read-out manuscript as a monochrome manuscript, and then outputs as achromatic data the processed image data stored in the read-out image memory 10 (S302). On the other hand, at step S301, when the data is determined as not achromatic, that is, as chromatic (S301: NO), the control section 1 determines the read-out manuscript as a color manuscript, and then outputs as chromatic data the processed image data stored in the read-out image memory 10 (S303).

According to the above-mentioned procedure, after a part (a logo mark or a background mark) not requiring color output is achromatized, it is determined whether the read-out manuscript is a color manuscript or a monochrome manuscript. By virtue of this, even when it is determined as a color manuscript, a part not requiring color output becomes achromatic so that color output is restricted.

(Embodiment 3)

In Embodiment 3, a processing method and an output method for read-out image data are described in which in order that a part not requiring color output should be achromatized exactly on a pixel basis, chromatic image data used as the reference for that part is prepared separately, and in which the read-out image data and the chromatic image data are then compared with each other so that achromatization processing is achieved accurately.

Here, the configuration of the image processing apparatus of Embodiment 3 is similar to that of Embodiment 1. Thus, the configuration of the image processing apparatus described in FIG. 1 is referred to herein, and its description is omitted. Further, also in the description of Embodiment 3, the manuscript to be read is a presentation sheet similarly to Embodiment 1.

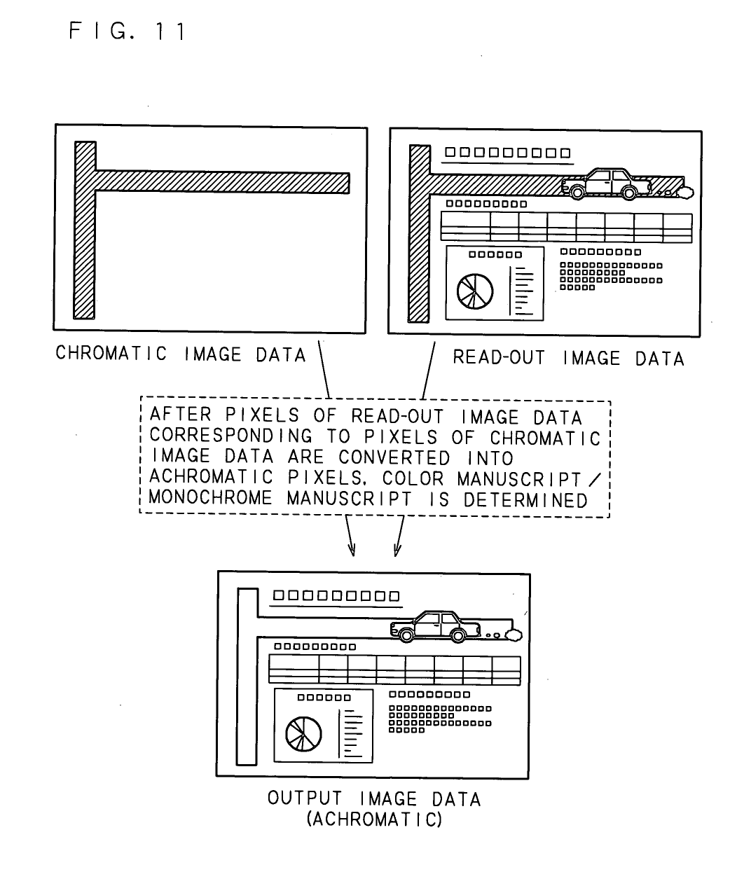

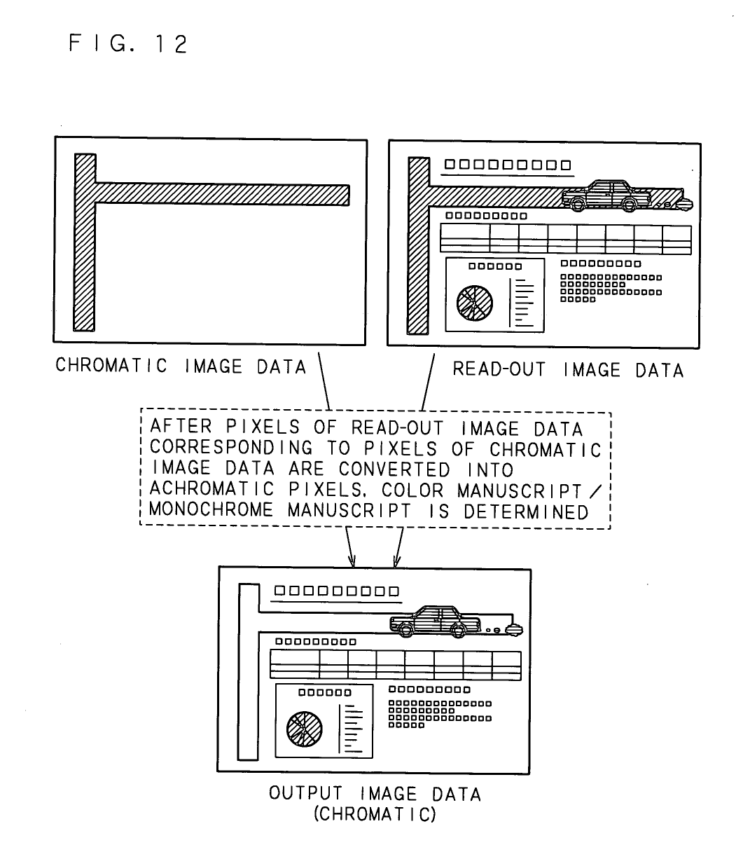

FIGS. 11 and 12 are diagrams showing the relation between chromatic image data/read-out image data/output image data for the determination of color manuscript/monochrome manuscript according to Embodiment 3 of the present invention. As seen from the read-out image data shown in FIGS. 11 and 12, an image of a car overlaps with a background mark not requiring color output in the read-out manuscript. When the image of the car is in color, color output need be performed on the image of the car except for the background mark.

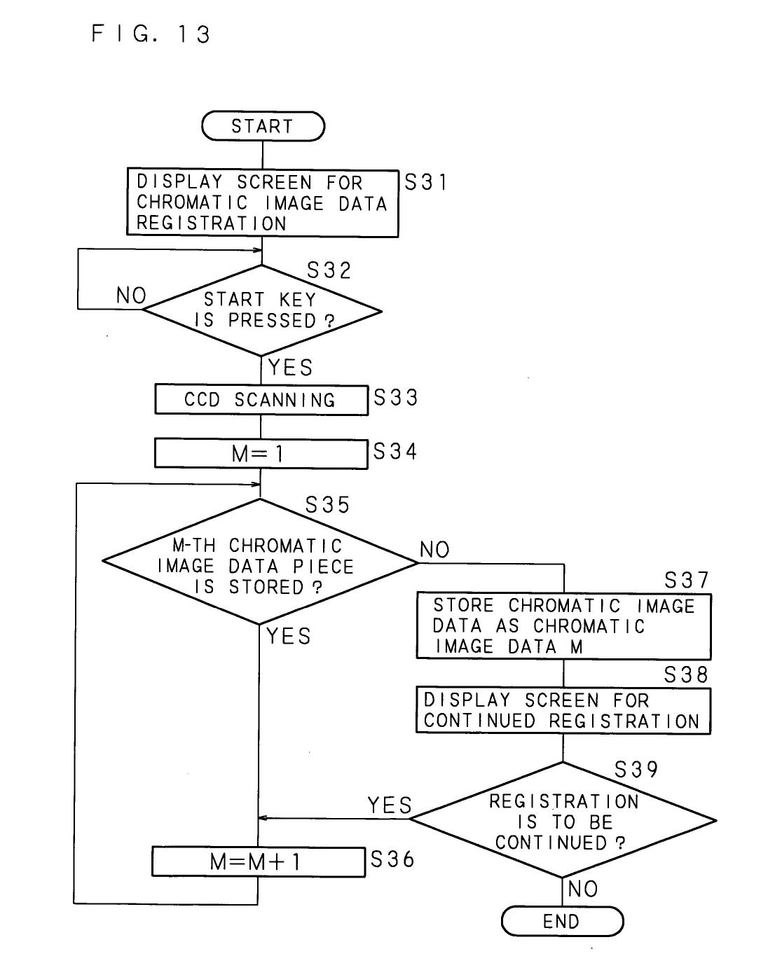

Here, described below is a procedure of storing read-out image data generated by the reading section 9 reading a manuscript provided with a chromatic image for restricting color output (referred to as a chromatic image manuscript, hereafter), as chromatic image data into the chromatic image memory 12. FIG. 13 is a flow chart showing a procedure of registration of chromatic image data performed by the control section 1 of the image processing apparatus according to Embodiment 3 of the present invention.

First, the control section 1 displays a screen for chromatic image data registration onto the display section 5 (S31), and then monitors the pressing of the start key of the operation section 6 serving as the input of an instruction of read start for the manuscript (S32). When the start key of the operation section 6 is not yet pressed (S32: NO), the control section 1 continues to monitor the pressing. On the other hand, when the start key has been pressed (S32: YES), the control section 1 scans the CCD of the reading section 9 (S33).

Then, the control section 1 sets, to be 1, the counter M for indicating the number of chromatic image data pieces (S34), and then determines whether the M-th chromatic image data piece is stored in the chromatic image memory 12 (S35). At step S35, when the data is determined as stored (S35: YES), the control section 1 increments the counter M by 1 (S36), and then the procedure goes to step S35 so that the control section 1 may repeat the subsequent processing. On the other hand, at step S35, when the data is determined as not stored (S35: NO), the control section 1 stores the chromatic image data generated by reading the chromatic image manuscript at step S33, as chromatic image data M in a manner corresponding to the numerical value of counter M into the chromatic image memory 12 (S37).

Next, the control section 1 displays a screen for continued registration onto the display section 5 (S38), and then determines whether the registration is to be continued, on the basis of the pressing of a function key of the operation section 6 (S39). At step S39, when it is determined that the registration is to be continued (S39: YES), the procedure goes to step S36, and then the control section 1 repeats the subsequent processing. On the other hand, at step S39, when it is determined that the registration is not to be continued (S39: NO), the control section 1 completes the processing.

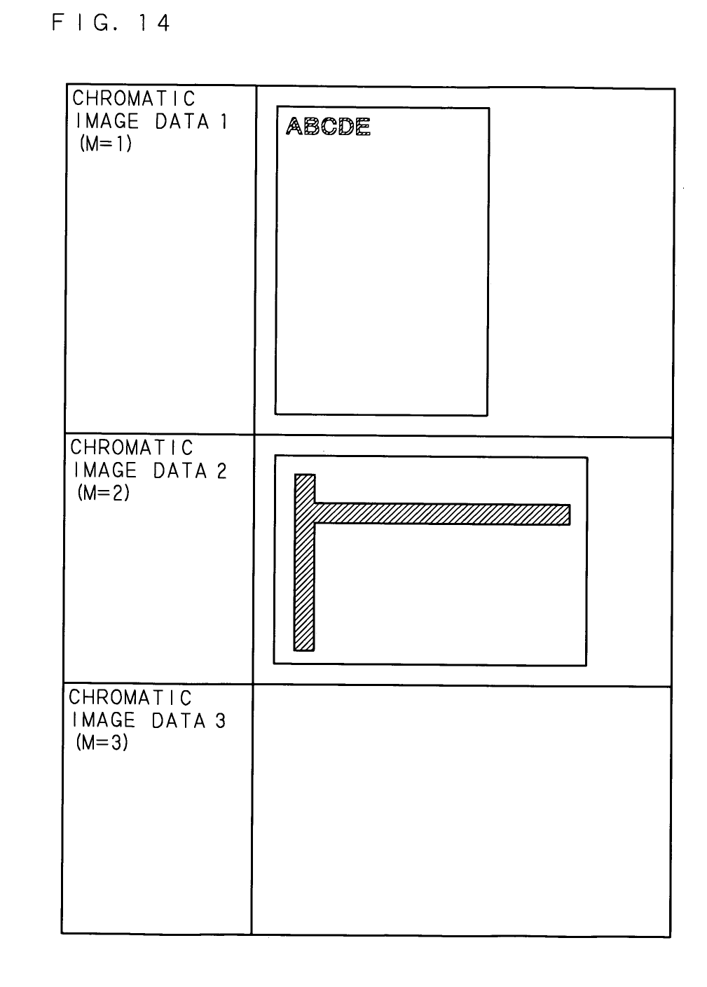

The chromatic image data stored into the chromatic image memory 12 according to the above-mentioned procedure is shown in FIG. 14. The chromatic image data 1 (M=1) shown in FIG. 14 has been generated by reading a manuscript provided with a logo mark. The chromatic image data 2 (M=2) corresponds to the chromatic image data shown in FIGS. 11 and 12.

In this example, the chromatic image data has been registered by reading a chromatic image manuscript. However, as described above, the chromatic image data may obviously be registered by receiving chromatic image data from a computer (external apparatus) via the interface section 7.

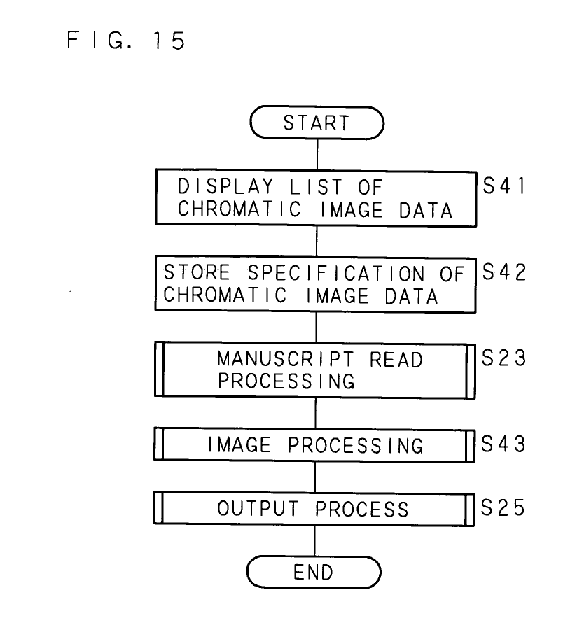

After the chromatic image data is registered as described above, image processing of the manuscript is performed. FIG. 15 is a flow chart showing a procedure of read-out image data processing and processed image data output performed by the control section 1 of the image processing apparatus according to Embodiment 3 of the present invention.

First, the control section 1 displays on the display section 5 a list of chromatic image data stored in the chromatic image memory 12 (S41), and then stores into the RAM 4 the specification of chromatic image data inputted through the operation section 6 (S42). In this example, chromatic image data shown in FIGS. 11 and 12 (chromatic image data 2 in FIG. 14) is specified.

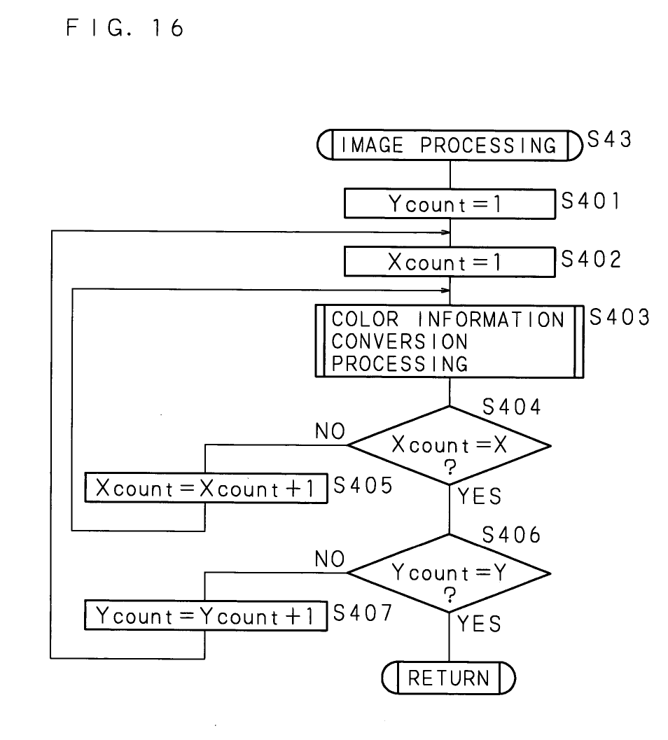

Next, the control section 1 performs manuscript read processing of the subroutine shown in FIG. 9 (S23), and then performs image processing (S43). This image processing according to Embodiment 3 of the present invention is described below. FIG. 16 is a flow chart showing a procedure of image processing performed by the control section 1 of the image processing apparatus according to Embodiment 3 of the present invention, which is a subroutine included in the flow chart of FIG. 15.

First, after the manuscript read processing (S23), the control section 1 sets, to be 1, the dot counter Ycount for indicating the coordinate of the pixel in the sub-scanning direction of the read-out image data (S401), and then sets, to be 1, the dot counter Xcount for indicating the coordinate of the pixel in the main scanning direction of the read-out image data (S402).

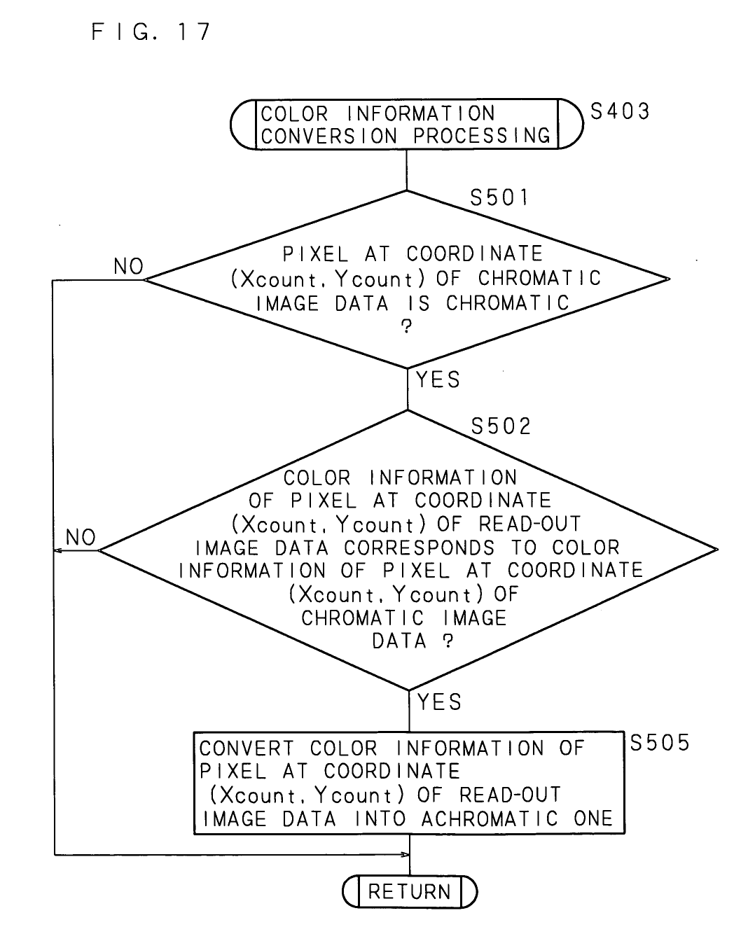

Then, the control section 1 performs color information conversion processing (S403). This color information conversion processing according to Embodiment 3 of the present invention is described below. FIG. 17 is a flow chart showing a procedure of color information conversion processing performed by the control section 1 of the image processing apparatus according to Embodiment 3 of the present invention, which is a subroutine included in the flow chart of FIG. 16.

After the processing of step S402 shown in FIG. 16, the control section 1 determines whether the color information of the pixel at the coordinate (Xcount, Ycount) of the chromatic image data specified at step S42 (see FIG. 15) is chromatic (S501). At step S501, when it is determined as not chromatic (S501: NO), the procedure returns to the subroutine of FIG. 16.

At step S501, when it is determined as chromatic (S501: YES), the control section 1 determines whether the color information of the pixel at the coordinate (Xcount, Ycount) of the read-out image data stored in the read-out image memory 10 corresponds to the color information of the pixel at the coordinate (Xcount, Ycount) of the chromatic image data (S502).

At step S502, when the information is determined as not corresponding (S502: NO), the procedure returns to the subroutine of FIG. 16. On the other hand, at step S502, when the information is determined as corresponding (S502: YES), the control section 1 converts the chromatic pixel at the coordinate (Xcount, Ycount) of the read-out image data into an achromatic pixel by means of a publicly known technique (S505), and then the procedure returns to the subroutine of FIG. 16.

After returning to the flow chart of FIG. 16, the control section 1 determines whether the dot counter Xcount indicates the final end coordinate X in the main scanning direction (S404). At step S404, when it is determined as not the final end coordinate X (S404: NO), the control section 1 increments the dot counter Xcount by 1 (S405), and then the procedure goes to the color information conversion processing of step S403 so that the control section 1 may repeat the subsequent processing. As a result, the color information of the pixels of one line of the read-out image data corresponding to the color information of the pixels of the chromatic image data is converted from chromatic one into achromatic one.

At step S404, when it is determined as the final end coordinate X (S404: YES), the control section 1 determines whether the dot counter Ycount indicates the final end coordinate Y in the sub-scanning direction (S406). At step S406, when it is determined as not the final end coordinate Y (S406: NO), the control section 1 increments the dot counter Ycount by 1 (S407), and then the procedure goes to step S402 so that the control section 1 may repeat the subsequent processing.

At step S406 when it is determined as the final end coordinate Y (S406: YES), the procedure returns to the main routine of FIG. 15. As a result, the color information of the pixels of one page of the read-out image data corresponding to the color information of the pixels of the chromatic image data is converted from chromatic one into achromatic one.

After returning to the flow chart of FIG. 15, the control section 1 performs the output processing of the subroutine shown in FIG. 10 on the processed image data in which the color information of the pixels of the read-out image data corresponding to the color information of the pixels of the chromatic image data has been converted from chromatic one into achromatic one (S25). Then, the control section 1 completes the processing.

According to the above-mentioned procedure, after a part (a logo mark or a background mark) not requiring color output is solely achromatized on a pixel basis, it is determined whether the read-out manuscript is a color manuscript or a monochrome manuscript. By virtue of this, even when it is determined as a color manuscript, a part not requiring color output becomes achromatic so that color output is restricted.

(Embodiment 4)

In Embodiment 4, a processing method and an output method for read-out image data is described in which a region of chromatic image is specified in chromatic image data so that the determination whether the color information of the pixels of the read-out image data in the specified region corresponds to the color information of the pixels of the chromatic image data is performed on a dot basis, that is, on a pixel basis, and in which achromatization processing is then performed on pixels determined as corresponding.

Here, the configuration of the image processing apparatus of Embodiment 4 is similar to that of Embodiment 1. Thus, the configuration of the image processing apparatus described in FIG. 1 is referred to herein, and its description is omitted. Further, also in the description of Embodiment 4, the manuscript to be read is a presentation sheet similarly to Embodiment 1.

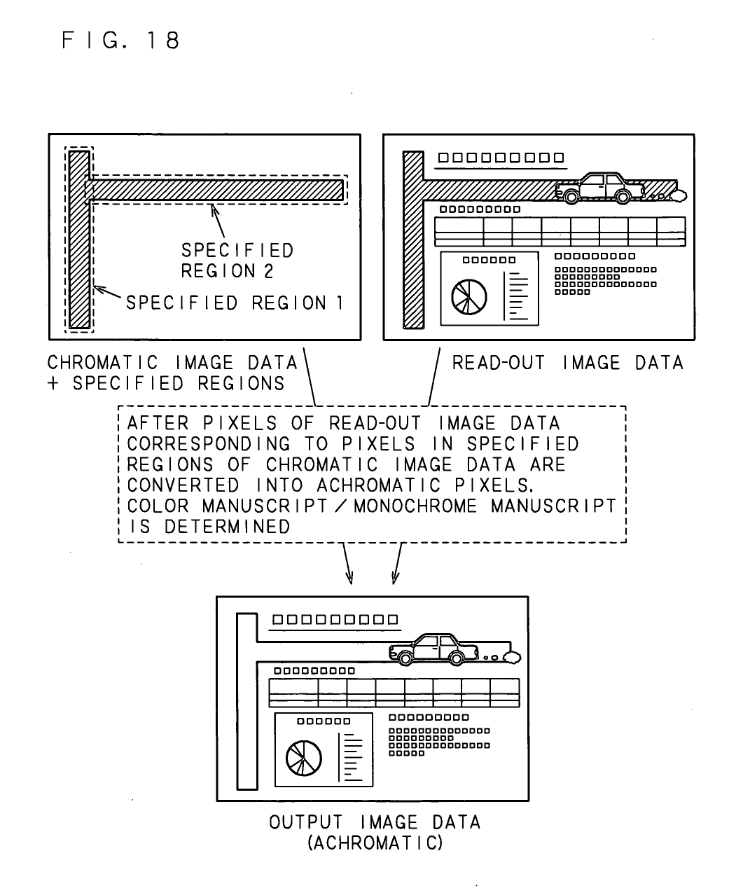

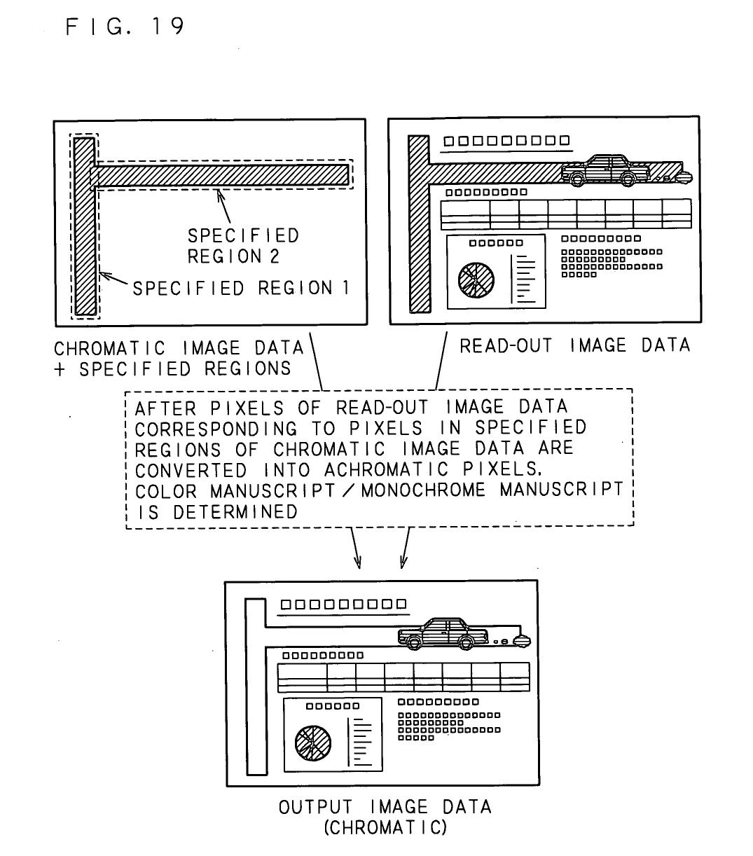

FIGS. 18 and 19 are diagrams showing the relation between chromatic image data+specified regions/read-out image data/output image data for the determination of color manuscript/monochrome manuscript according to Embodiment 4 of the present invention. Described below is a procedure of storing the chromatic image data and the specified regions shown in FIGS. 18 and 19 into the chromatic image memory 12 and the specified region memory 13 in such a manner that the chromatic image data is in correspondence to the specified regions.

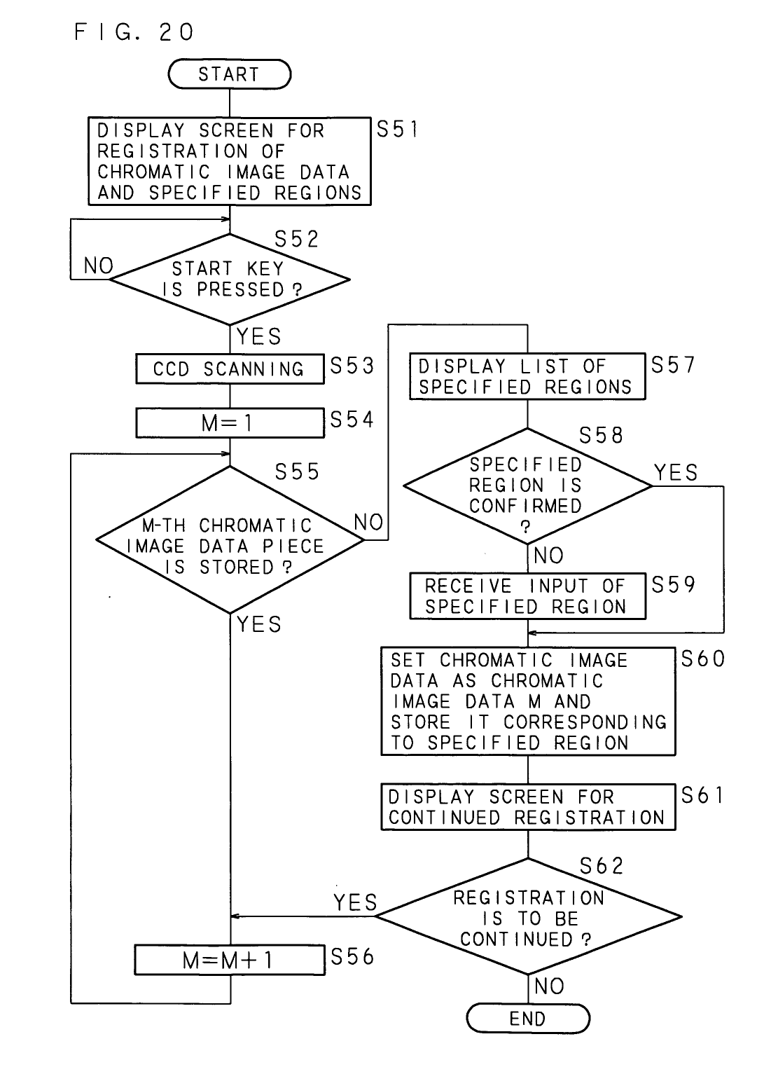

FIG. 20 is a flow chart showing a procedure of registration of chromatic image data and specified regions performed by the control section 1 of the image processing apparatus according to Embodiment 4 of the present invention.

First, the control section 1 displays a screen for the registration of chromatic image data and specified regions onto the display section 5 (S51), and then monitors the pressing of the start key of the operation section 6 serving as the input of an instruction of read s tart for the manuscript (S52). When the start key of the operation section 6 is not yet pressed (S52: NO), the control section 1 continues to monitor the pressing. On the other hand, when the start key has been pressed (S52: YES), the control section 1 scans the CCD of the reading section 9 (S53).

Then, the control section 1 sets, to be 1, the counter M for indicating the number of chromatic image data pieces (S54), and then determines whether the M-th chromatic image data piece is stored in the chromatic image memory 12 (S55). At step S55, when the data is determined as stored (S55: YES), the control section 1 increments the counter M by 1 (S56), and then the procedure goes to step S55 so that the control section 1 may repeat the subsequent processing. On the other hand, at step S55, when the data is determined as not stored (S55: NO), the control section 1 decodes the chromatic image data generated by reading the chromatic image manuscript at step S53, and then displays as specified regions a list of N sets (N=1, 2, 3,. . . depending on the shape or the number of the chromatic images) of rectangle coordinates (start coordinate (Xstart, Ystart) and ending coordinate (Xend, Yend)) each indicating an image region, onto the display section 5 (S57).

Then, on the basis of the pressing of the function key of the operation section 6, the control section 1 determines whether the specified region is to be confirmed (S58). At step S58, when it is determined that the specified region is to be confirmed (S58: YES), the procedure goes to step S60 described later so that the control section 1 may repeat the subsequent processing. On the other hand, at step S58, when it. is determined that the specified region is not to be confirmed (S58: NO), the control section 1 receives the input of a specified region from a user through the function keys and the ten-key pad of the operation section 6 (S59). At the time, a user inputs numerical values for the coordinates by using the operation section 6 in such a manner that an arbitrary specified region among the N pieces of specified regions displayed on the display section 5 should approach the contour of the chromatic image as much as possible (that is, the area of the rectangular region should be reduced). Then, the N specified regions are confirmed.

Then, the control section 1 sets the chromatic image data generated by reading the chromatic image manuscript at step S53 to be chromatic image data M corresponding to the numerical value of the counter M. Further, the control section 1 establishes the correspondence of each chromatic image data M with the N specified regions, and then stores the chromatic image data and the specified regions into the chromatic image memory 12 and the specified region memory 13, respectively (S60).

Next, the control section 1 displays a screen for continued registration onto the display section 5 (S61), and then determines whether the registration is to be continued, on the basis of the pressing of a function key of the operation section 6 (S62). At step S62, when it is determined that the registration is to be continued (S62: YES), the procedure goes to step S56, and then the control section 1 repeats the subsequent processing. On the other hand, at step S62, when it is determined that the registration is not to be continued (S62: NO), the control section 1 completes the processing.

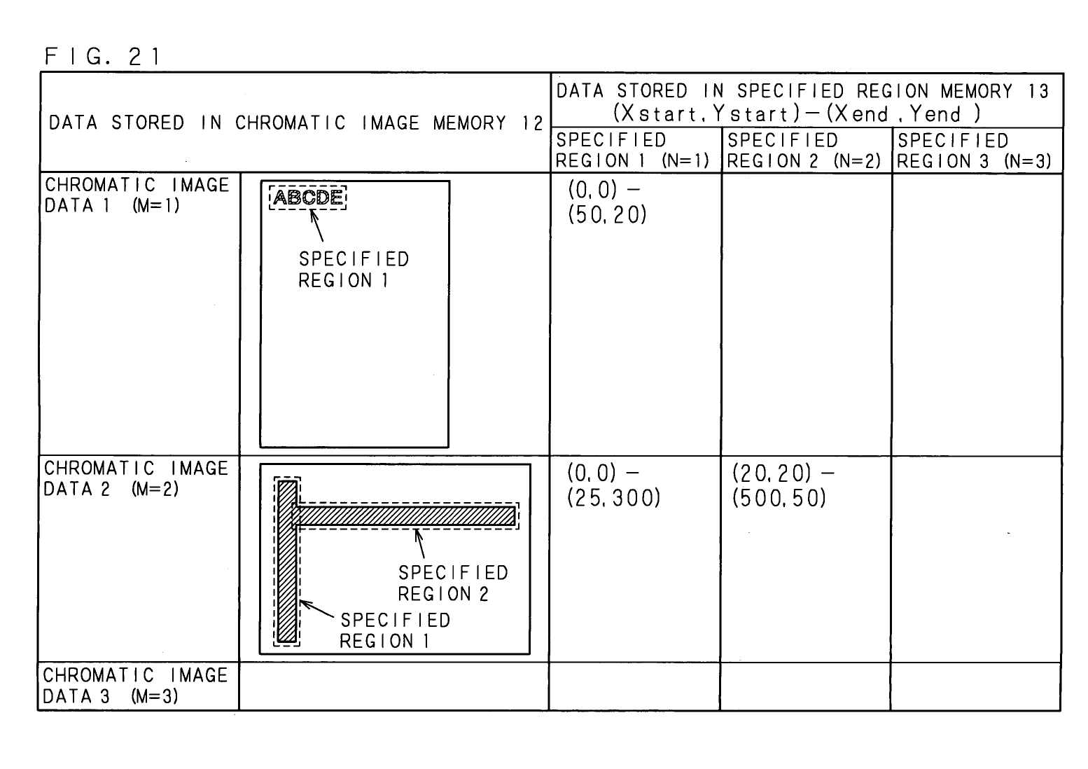

The chromatic image data and the specified regions stored into the chromatic image memory 12 and the specified region memory 13 according to the above-mentioned procedure are shown in FIG. 21. The chromatic image data 1 (M=1) shown in FIG. 21 has been generated by reading a manuscript provided with a logo mark. The chromatic image data 2 (M=2) corresponds to the chromatic image data shown in FIGS. 18 and 19.

In this example, the chromatic image data and the specified region data have been registered by reading a chromatic image manuscript. However, as described above, the chromatic image data may obviously be registered by receiving chromatic image data and specified regions from a computer (external apparatus) via the interface section 7.

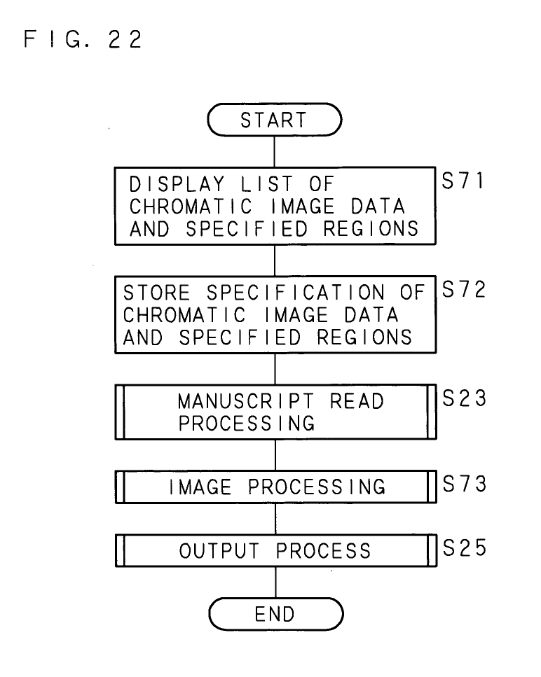

After the chromatic image data and the specified region are registered as described above, image processing of the manuscript is performed. FIG. 22 is a flow chart showing a procedure of read-out image data processing and processed image data output performed by the control section 1 of the image processing apparatus according to Embodiment 4 of the present invention.

First, the control section 1 displays onto the display section 5 a list of the chromatic image data and the specified regions stored in the chromatic image memory 12 and the specified region memory 13 (S71), and then stores into the RAM 4 the specification of chromatic image data and specified regions inputted through the operation section 6 (S72). In this example, the chromatic image data and the specified regions shown in FIGS. 18 and 19 (chromatic image data 2 (M=2) and specified regions 1 and 2 (N=1, 2) of the chromatic image data 2 in FIG. 21) are specified.

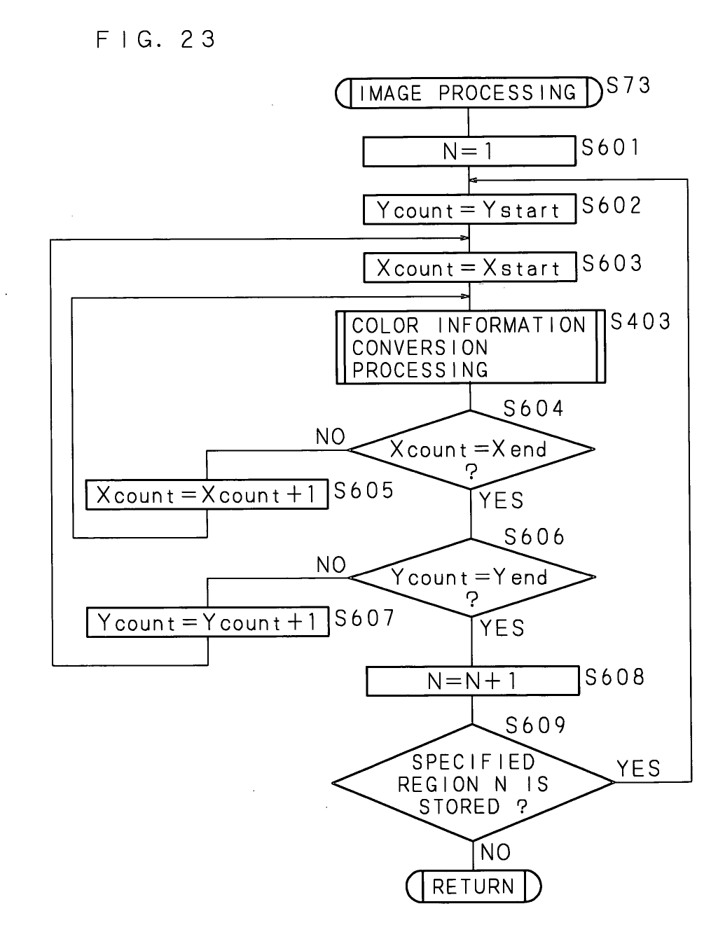

Next, the control section 1 performs manuscript read processing of the subroutine shown in FIG. 9 (S23), and then performs image processing (S73). This image processing according to Embodiment 4 of the present invention is described below. FIG. 23 is a flow chart showing a procedure of image processing performed by the control section 1 of the image processing apparatus according to Embodiment 4 of the present invention, which is a subroutine included in the flow chart of FIG. 22.

First, after the manuscript read processing (S23), the control section 1 sets, to be 1, the counter N for indicating a specified region in which chromatic output is to be suppressed (S601). Next, the control section 1 extracts the coordinate data of a specified region N corresponding to the chromatic image data specified at step S72 (see FIG. 22), then sets, to be Ystart, the dot counter Ycount for indicating the coordinate of the pixel in the sub-scanning direction of the specified region N (S602), then sets, to be Xstart, the dot counter Xcount for indicating the coordinate of the pixel in the main scanning direction of the specified region N (S603), and then performs color information conversion processing of the subroutine shown in FIG. 17 (S403).

Next, after the color information conversion processing (S403), the control section 1 determines whether the dot counter Xcount indicates the final coordinate Xend in the main scanning direction (S604). At step S604, when it is determined as not the final coordinate Xend (S604: NO), the control section 1 increments the dot counter Xcount by 1 (S605), and then the procedure goes to the color information conversion processing of step S403 so that the control section 1 repeat the subsequent processing. As a result, the color information of the pixels of one line of the read-out image data corresponding to the color information of the pixels of the chromatic image data in the specified region N is converted from chromatic one into achromatic one. At step S604, when it is determined as the final coordinate Xend (S604: YES), the control section 1 determines whether the dot counter Ycount indicates the final coordinate Yend in the sub-scanning direction (S606).

At step S606, when it is determined as not the final coordinate Yend (S606: NO), the control section 1 increments the dot counter Ycount by 1 (S607), and then the procedure goes to step S603 so that the control section 1 repeat the subsequent processing. As a result, the color information of all the pixels of the read-out image data corresponding to the color information of the pixels of the chromatic image data in the specified region N is converted from chromatic one into achromatic one.

At step S606, when it is determined as the final coordinate Yend (S606: YES), the control section 1 increments by 1 the counter N for indicating a specified region in which chromatic output is to be suppressed (S608), and then determines whether the specified region N corresponding to the chromatic image data specified at step S72 (see FIG. 22) is stored in the specified region memory 13 (S609). At step S609, when it is determined as stored (S609: YES), the procedure goes to step S602, and then the control section 1 repeats the subsequent processing. On the other hand, at step S609, when it is determined as not stored (S609: NO), the procedure returns to the main routine of FIG. 22.

After returning to the flow chart of FIG. 22, the control section 1 performs the output processing of the subroutine shown in FIG. 10 on the processed image data in which the color information of the pixels of the read-out image data corresponding to the color information of the pixels of the chromatic image data has been converted from chromatic one into achromatic one (S25). Then, the control section 1 completes the processing.

According to the above-mentioned procedure, a part (a logo mark or a background mark) not requiring color output in the specified region is solely achromatized on a pixel basis in a short time. Thus, after that, the determination whether the read-out manuscript is a color manuscript or a monochrome manuscript is performed in a short time. Further, similarly to Embodiment 3, even when it is determined as a color manuscript, a part not requiring color output becomes achromatic so that color output is restricted.

(Embodiment 5)

In Embodiment 5, a processing method and an output method for read-out image data is described in which a positioning mark is added to chromatic image data while the same positioning mark as the positioning mark of the chromatic image data is added also to the manuscript at a corresponding position, and in which in a state that the positioning mark of the read-out image data generated by reading the manuscript is aligned with the positioning mark of the chromatic image data, the determination whether the color information of both pixels of the chromatic image data and the read-out image data corresponds to each other is performed on a pixel basis so that achromatization processing is then performed on pixels determined as corresponding.

Here, the configuration of the image processing apparatus of Embodiment 5 is similar to that of Embodiment 1. Thus, the configuration of the image processing apparatus described in FIG. 1 is referred to herein, and its description is omitted. Further, also in the description of Embodiment 5, the manuscript to be read is a presentation sheet similarly to Embodiment 1.

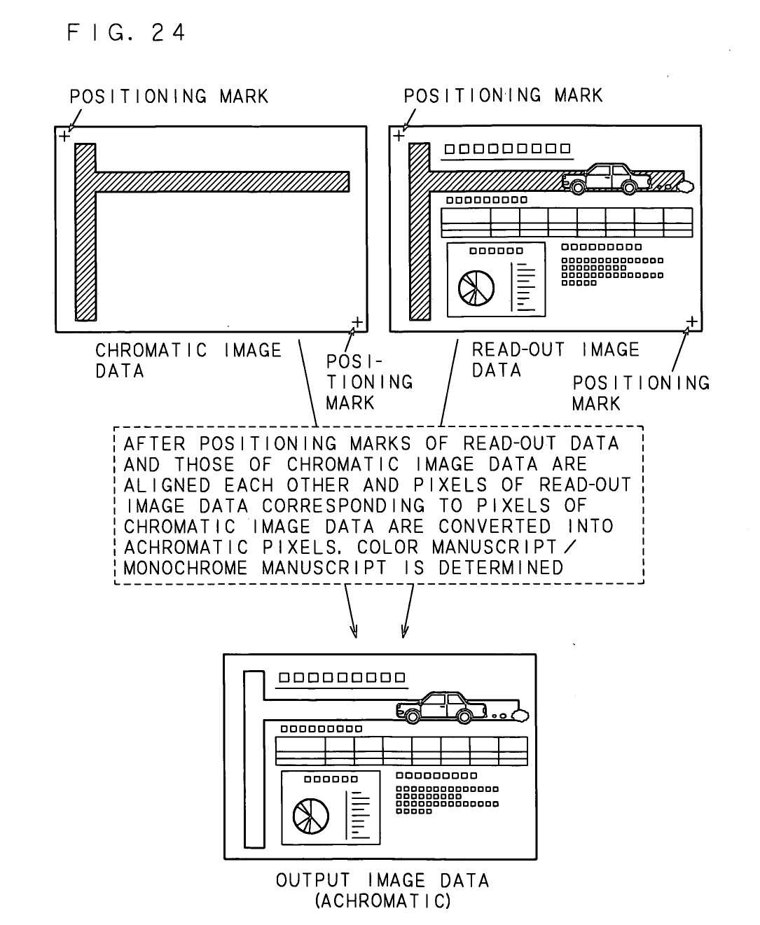

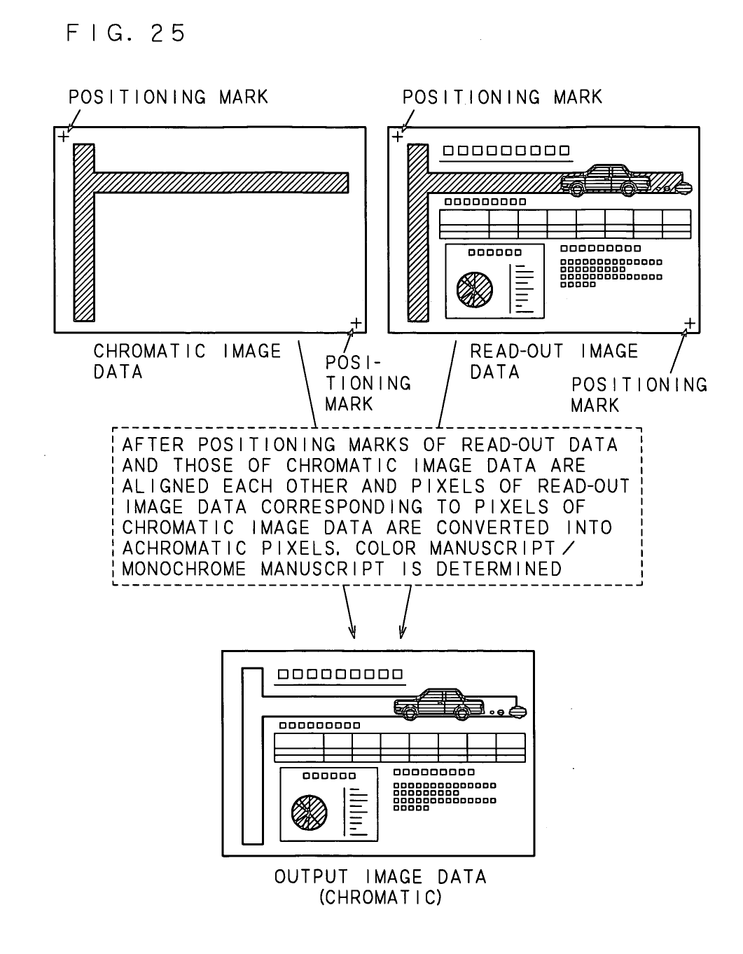

FIGS. 24 and 25 are diagrams showing the relation between chromatic image data+positioning marks/read-out image data/output image data for the determination of color manuscript/monochrome manuscript according to Embodiment 5 of the present invention. As shown in FIGS. 24 and 25, the positioning marks of the chromatic image data are “+” marks, and located at an upper left corner and a lower right corner of the chromatic image data in a front view. The chromatic image data provided with the positioning marks is stored into the chromatic image memory 12 by a procedure similar to that described above, in prior to the image processing of the manuscript when the reading section 9 reads the manuscript (chromatic image manuscript) provided with a chromatic image and positioning marks and thereby generates the data or alternatively when the data is received from a computer (external apparatus) via the interface section 7.

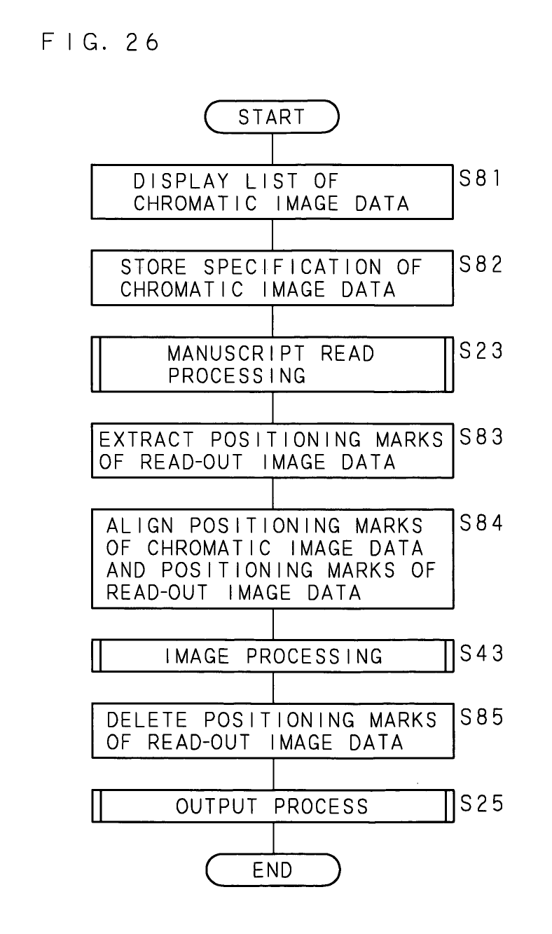

After the chromatic image data provided with positioning marks is registered as described above, image processing of the manuscript is performed. FIG. 26 is a flow chart showing a procedure of read-out image data processing and processed image data output performed by the control section 1 of the image processing apparatus according to Embodiment 5 of the present invention.

First, the control section 1 displays on the display section 5 a list of chromatic image data stored in the chromatic image memory 12 (S81), and then stores into the RAM 4 the specification of chromatic image data inputted through the operation section 6 (S82).

Next, after performing the manuscript read processing (S23) of the subroutine shown in FIG. 9, the control section 1 extracts the same positioning marks as the positioning marks of the chromatic image data specified at step S82 from the read-out image data stored in the read-out image memory 10 (S83). Then, the control section 1 performs alignment between the positioning marks of the chromatic image data and the positioning marks of the read-out image data (S84). This corrects the positional shift or rotational deviation of the read-out image data.

Next, after performing the image processing (S43) of the subroutine shown in FIG. 16, the control section 1 deletes the positioning marks of the read-out image data stored in the read-out image memory 10 (S85). Then, the control section 1 performs the output processing of the subroutine shown in FIG. 10 on the processed image data in which the color information of the pixels of the read-out image data corresponding to the color information of the pixels of the chromatic image data has been converted from chromatic one into achromatic one and in which the positioning marks have been deleted (S25). Then, the control section 1 completes the processing.

According to the above-mentioned procedure, regardless of the shift or rotation described here, the determination whether the color information of both pixels of the read-out image data and the chromatic image data corresponds to each other is performed accurately on a pixel basis in a state that the read-out image data and the chromatic image data are appropriately aligned with each other.

Here, in Embodiment 5, in a state that both image data pieces of the chromatic image data and the read-out image data are aligned with each other, the determination whether the color information corresponds to each other is performed on the entire pixels of both image data pieces. However, similarly to Embodiment 4, a region of chromatic image may be specified in the chromatic image data so that determination may be performed whether the color information of the pixels of the read-out image data in the specified region corresponds to the color information of the pixels of the chromatic image data. In this case, the image processing of step S43 shown in FIG. 16 is changed into the image processing of step S73 shown in FIG. 23.

(Embodiment 6)

In Embodiment 6, a processing method and an output method for read-out image data is described in which even when a difference arises in the color information of the pixels of the read-out image data relative to the actual color of the image of the manuscript, it is determined whether the difference between the color information of the pixels of the read-out image data and the color information of the pixels of the chromatic image data falls within a predetermined range, and in which when it is determined that the difference falls within the predetermined range, the color information of the pixels of the read-out image data is considered as corresponding to the color information of the pixels of the chromatic image data so that pixels considered as corresponding are achromatized.

Here, the configuration of the image processing apparatus of Embodiment 6 is similar to that of Embodiment 1. Thus, the configuration of the image processing apparatus described in FIG. 1 is referred to herein, and its description is omitted. Further, Embodiment 6 is described with reference to FIGS. 24 through 26.

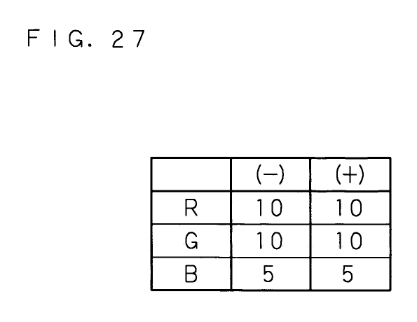

FIG. 27 is a diagram showing a state that color information difference allowable range data is stored in the color information difference allowable range table memory 14. The color information difference allowable range data shown in FIG. 27 is stored into the color information difference allowable range table memory 14 in prior to the image processing of the manuscript when the data is inputted by a user through the operation section 6 or alternatively when the data is received from a computer (external apparatus) via the interface section 7. For specific chromatic image data, when read-out image data falls within the color information difference allowable range, the color information is considered as corresponding to each other in both pixels so that chromatic pixels of the read-out image data are converted into achromatic pixels. This avoids the problem of difference in the color information.

When the color information at the same position (the same coordinate) of the read-out image data and the chromatic image data is expressed by Rg/Gg/Bg and Rf/Gf/Bf in RGB components, respectively, in a case that the values of the color information difference allowable range data shown in FIG. 27 are used and that ((Rf−10)≦Rg≦(Rf+10)) and ((Gf−10)≦Gg≦(Gf+10)) and ((Bf−5)≦Bg ≦(Bf+5)) is satisfied, the color information is considered as corresponding to each other in both pixels so that chromatic pixels of the read-out image data are converted into achromatic pixels. When the above-mentioned relation is not satisfied, the color information is considered as not corresponding to each other in both pixels so that the color information of the pixels of the read-out image data is not converted.

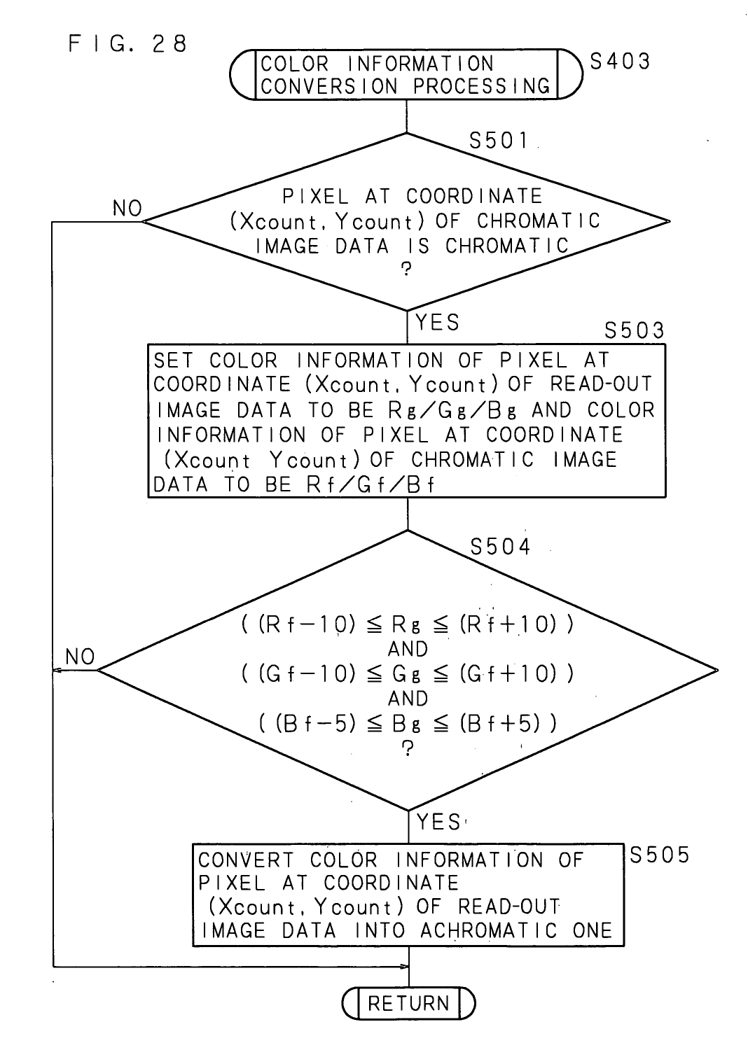

Here, in Embodiment 6, FIGS. 24 through 26 are referred to. Thus, as for the image processing of the manuscript, a modification for the color information conversion processing of step S403 of FIG. 17 is described below. FIG. 28 is a flow chart showing a procedure of color information conversion processing performed by the control section 1 of the image processing apparatus according to Embodiment 6 of the present invention, which is a subroutine included in the flow chart of FIG. 16 (or FIG. 23). Here, steps S501 and S505 in FIG. 28 are the same as steps S501 and S505 in FIG. 17, respectively. Thus, their description is omitted.

In the processing of step S501, when it is determined as chromatic (S501: YES), the control section 1 sets the RGB components of the color information of the pixel at the coordinate (Xcount, Ycount) of the read-out image data to be Rg/Gg/Bg respectively and the RGB components of the color information of the pixel at the coordinate (Xcount, Ycount) of the chromatic image data to be Rf/Gf/Bf respectively (S503).

Next, for the purpose of determination whether the difference between the color information Rg/Gg/Bg and Rf/Gf/Bf falls within a allowable range, the control section 1 refers to the color information difference allowable range data stored in the color information difference allowable range table memory 14. For example, when each element of RGB falls within the range of 0 through 255 while Rg/Gg/Bg fall within the value ranges of R:−10 through+10, G:−10 through+10, and B:−5 through +5 relative to Rf/Gf/Bf as shown in FIG. 27, the color information is considered as corresponding to each other in both pixels so that chromatic pixels of the read-out image data are converted into achromatic pixels. Thus, at this time, the control section 1 determines whether the discriminant ((Rf−10)≦Rg≦(Rf+10)) and ((Gf−10)≦Gg≦(Gf+10)) and ((Bf−5)≦Bg≦(Bf+5)) is satisfied (S504).

At step S504, when the discriminant is determined as satisfied (S504: YES), the control section 1 performs the processing of step S505, and then the procedure returns to the subroutine of FIG. 16 (or FIG. 23). On the other hand, at step S504, when the discriminant is determined as not satisfied (S504: NO), the procedure returns to the subroutine of FIG. 16 (or FIG. 23).

According to the above-mentioned procedure, even when a difference arises in the color information of the pixels of the read-out image data relative to the actual color of the image of the manuscript, the conversion of the color information of the pixels of the read-out image data into the achromatic is performed flexibly in such a manner that the read-out image data is considered as corresponding to the color information of the chromatic image data.

Here, the color information difference allowable range data shown in FIG. 27 may be set up for each chromatic image data when a plurality of chromatic image data pieces are registered. Further, when the output destination device for the processed image data is fixed, the allowable range of the color information difference allowable range data may be set to be narrow, while when there are a plurality of output destination devices, the allowable range may be set to be wide.

(Embodiment 7)

In Embodiment 7, a processing method and an output method for read-out image data are described in which in-advance registration of chromatic image data is not performed while chromatic image data is registered at the same time as the reading of the manuscript.

Here, the configuration of the image processing apparatus of Embodiment 7 is similar to that of Embodiment 1. Thus, the configuration of the image processing apparatus described in FIG. 1 is referred to herein, and its description is omitted. Further, Embodiment 7 is described for the case that the manuscript to be read is a document manuscript provided with a logo mark.

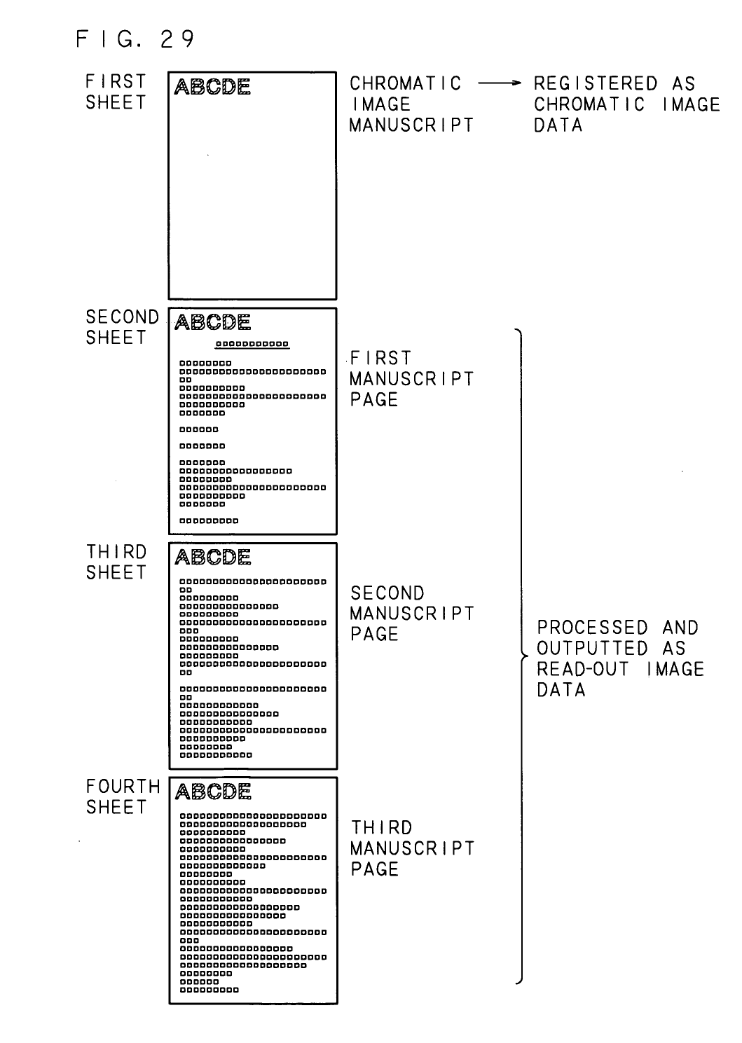

FIG. 29 is a diagram describing the order of reading manuscript sheets according to Embodiment 7 of the present invention. As shown in FIG. 29, a user sets a chromatic image manuscript prior to the manuscript for image processing. Thus, reading is performed in the order of chromatic image manuscript→first manuscript page→second manuscript page→. . . . Then, on the image processing apparatus side, the read-out image data of the first sheet of the read-out manuscript (chromatic image manuscript) is determined as chromatic image data, while the read-out image data of the second and subsequent sheets of the read-out manuscript is determined as the read-out image data of the first and subsequent pages of the manuscript.

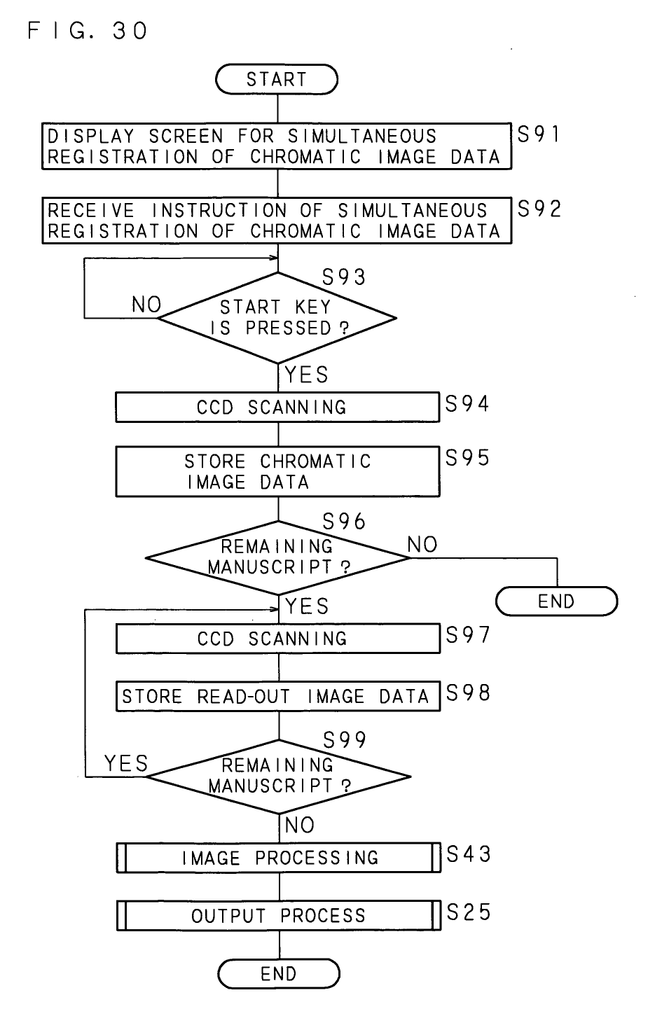

Next, image processing of the manuscript is described below. FIG. 30 is a flow chart showing a procedure of read-out image data processing and processed image data output performed by the control section 1 of the image processing apparatus according to Embodiment 7 of the present invention.

First, the control section 1 displays a screen for simultaneous registration of chromatic image data onto the display section 5 (S91), and then receives the input of an instruction of simultaneous registration of chromatic image data provided from a user through the operation section 6 (S92).

Next, the control section 1 monitors the pressing of the start key of the operation section 6 serving as the input of an instruction of read start for the manuscript (S93). When the start key of the operation section 6 is not yet pressed (S93: NO), the control section 1 continues to monitor the pressing. On the other hand, when the start key has been pressed (S93: YES), the control section 1 scans the CCD of the reading section 9 (S94), and then stores chromatic image data generated by reading the first manuscript sheet (chromatic image manuscript), as the (M-th) chromatic image data into the chromatic image memory 12 (S95).

Then, the control section 1 determines the presence or absence of a remaining manuscript not yet read by the reading section 9 (S96). When the absence of a manuscript not yet read is concluded (S96: NO), the control section 1 completes the processing. That is, in this case, the registration of chromatic image data is solely performed. On the other hand, when the presence of a manuscript not yet read is concluded (S96: YES), the control section 1 scans the CCD of the reading section 9 (S97), and then stores read-out image data generated by reading the second manuscript sheet, into the read-out image memory 10 (S98).

Then, the control section 1 determines the presence or absence of a remaining manuscript not yet read by the reading section 9 (S99). When the presence of a manuscript not yet read is concluded (S99: YES) (that is, when the third or subsequent manuscript sheet is present), the procedure goes to step S97 so that the control section 1 may repeat the subsequent processing. On the other hand, when the absence of a manuscript not yet read is concluded (S99: NO), the control section 1 performs the image processing of the subroutine shown in FIG. 16 on the chromatic image data stored into the chromatic image memory 12 at step S95 and the read-out image data stored into the read-out image memory 10 at step S98 (S43). Then, the control section 1 performs the output processing of the subroutine shown in FIG. 10 (S25), and then completes the processing.

According to the above-mentioned procedure, the in-advance registration of chromatic image data becomes unnecessary. Further, serial operation of successively reading a plurality of manuscript sheets is sufficient, and hence it is not necessary to select chromatic image data corresponding to the manuscript. This improves the operability in image processing.

(Embodiment 8)

In Embodiment 8, a processing method and an output method for read-out image data are described below in which without the necessity that a user should select chromatic image data and a specified region having been registered in advance, a manuscript is read that is provided with a chromatic image data identification code and a specified region identification code (referred to as an identification code, hereafter) for selecting chromatic image data and a specified region, and in which at the same time as this reading, an image processing apparatus automatically selects chromatic image data and a specified region having been registered in advance.

Here, the configuration of the image processing apparatus of Embodiment 8 is similar to that of Embodiment 1. Thus, the configuration of the image processing apparatus described in FIG. 1 is referred to herein, and its description is omitted. Further, also in the description of Embodiment 8, the manuscript to be read is a presentation sheet similarly to Embodiment 1.

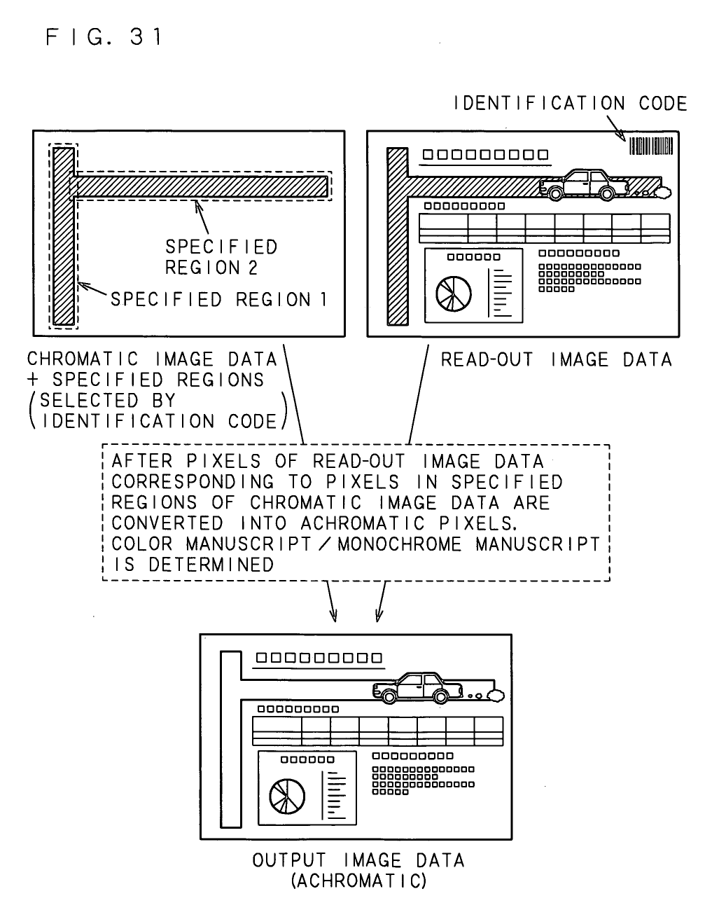

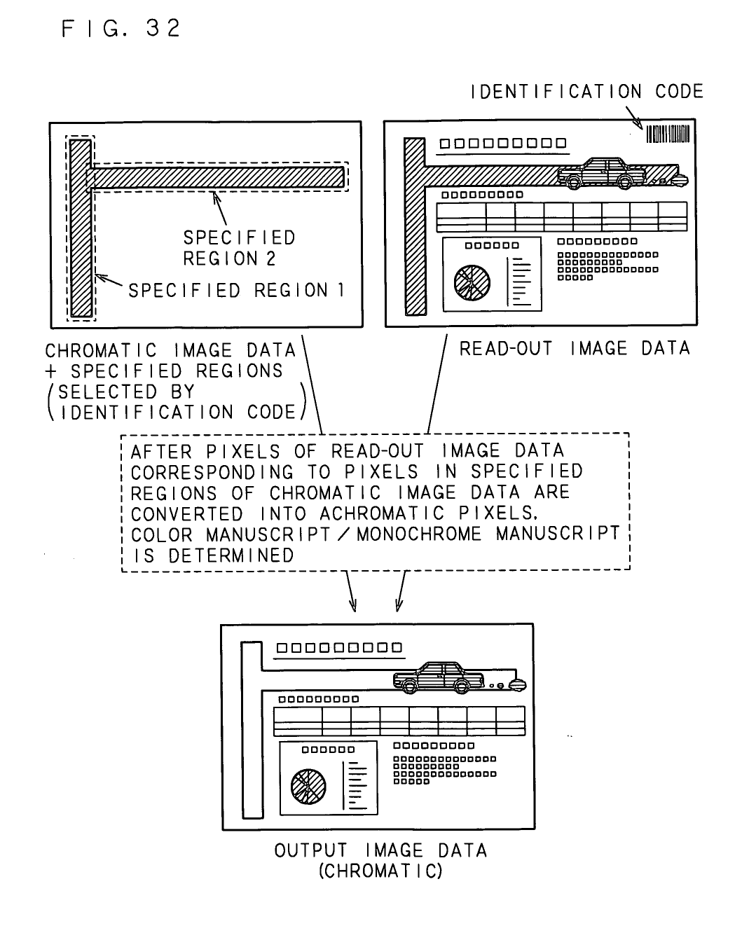

FIGS. 31 and 32 are diagrams showing the relation between chromatic image data+specified regions/read-out image data/output image data for the determination of color manuscript/monochrome manuscript according to Embodiment 8 of the present invention. As shown in FIGS. 31, and 32, an identification code (bar code) for selecting chromatic image data and a specified region is added on the upper right side of the read-out image data in a front view. Further, the chromatic image data and the specified regions 1 and 2 shown in FIGS. 31 and 32 are the same as those of FIGS. 18 and 19 of Embodiment 4, and are stored as the chromatic image data 2 (M=2) and the specified regions 1 and 2 (N=1, 2) of the chromatic image data 2 in a manner corresponding to the identification code as shown in FIG. 21 in the chromatic image memory 12 and the specified region memory 13 in prior to the image processing of the manuscript by a procedure similar to that described above.

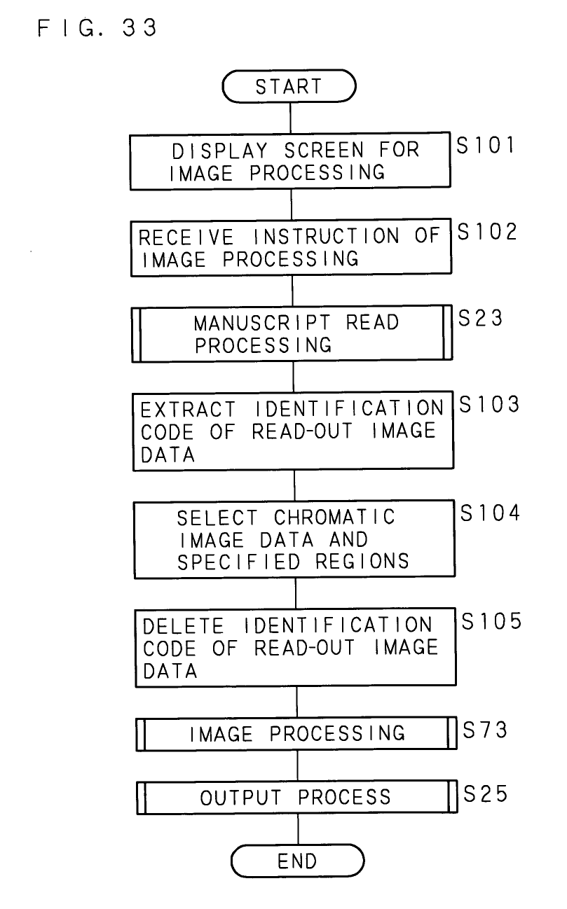

After the chromatic image data and the specified regions are registered in a manner corresponding to the identification code as described above, image processing of the manuscript is performed. FIG. 33 is a flow chart showing a procedure of read-out image data processing and processed image data output performed by the control section 1 of the image processing apparatus according to Embodiment 8 of the present invention.

First, the control section 1 displays a screen for image processing on the display section 5 (S101), and then receives the input of an instruction of image processing provided from a user through the operation section 6 (S102).

Next, after performing the manuscript read processing (S23) of the subroutine shown in FIG. 9, the control section 1 extracts the identification code from the read-out image data stored in the read-out image memory 10 (S103). Then, on the basis of the extracted identification code, the control section 1 selects chromatic image data and specified regions stored in the chromatic image memory 12 and the specified region memory 13 (S104). In this example, the chromatic image data and the specified regions shown in FIGS. 31 and 32 (chromatic image data 2 (M=2) and specified regions 1 and 2 (N=1, 2) of the chromatic image data 2 in FIG. 21) are specified. Then, the control section 1 deletes the identification code of the read-out image data stored in the read-out image memory 10 (S105).

Then, the control section 1 performs the image processing (S73) of the subroutine shown in FIG. 23, and then performs the output processing of the subroutine shown in FIG. 10 on the processed image data in which the color information of the pixels of the read-out image data corresponding to the color information of the pixels of the chromatic image data has been converted from chromatic one into achromatic one (S25). Then, the control section 1 completes the processing.

According to the above-mentioned procedure, when reading operation for a manuscript provided with an identification code (chromatic image data identification code and specified region identification code) is merely performed, on the basis of the identification code extracted from the read-out image data, chromatic image data and a specified region having been stored in the chromatic image data memory 12 and the specified region memory 13 are automatically selected at the image processing apparatus side. Thus, the selection of chromatic image data and a specified region performed by a user becomes unnecessary so that operability is improved.

(Embodiment 9)

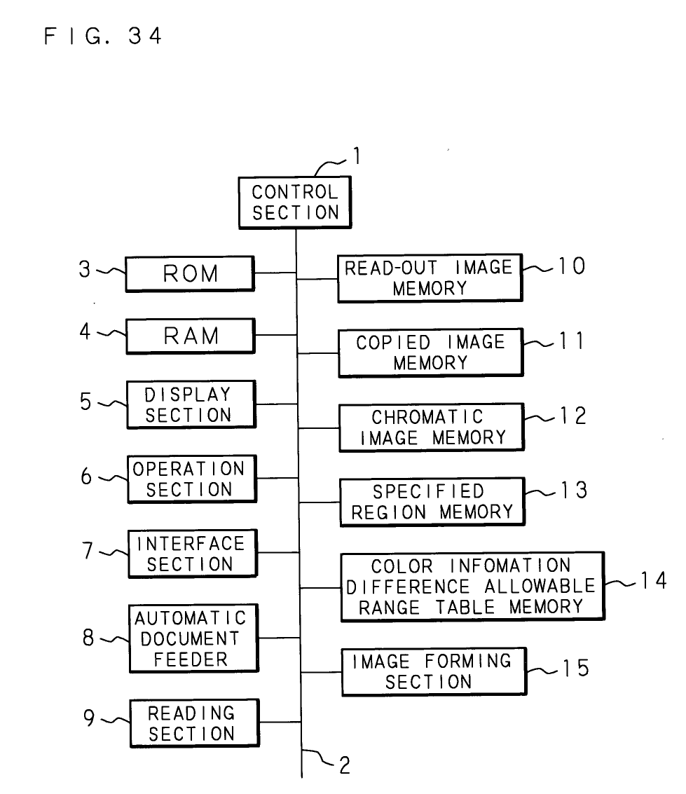

FIG. 34 is a block diagram showing the configuration of an image forming apparatus according to Embodiment 9 in a case where the present invention is applied to a multi-functional machine having a scanner function, a copy function, a print function, and a facsimile function. The image forming apparatus shown in FIG. 34 comprises the configuration of the image processing apparatus shown in FIG. 1, and further comprises an image forming section 15 connected to the control section 1 via the bus 2.

The image forming section 15 comprises, for example: an electrostatic charger for charging a photosensitive drum into a predetermined potential; a laser write unit for emitting laser light in accordance with processed image data generated by the control section 1 processing read-out image data, and thereby generating an electrostatic latent image on the surface of the photosensitive drum; a developer for supplying toner onto the electrostatic latent image generated on the photosensitive drum surface, and thereby causing the image to be visible; and a transfer unit for transferring the toner image formed on the surface of the photosensitive drum, onto a recording medium (for example, a paper sheet) (not shown). Then, on the basis of the control performed by the control section 1, the image forming section 15 performs image formation of the processed image data onto a recording medium by electrophotography. The other points of the configuration, as well as the control performed by the control section 1, are the same as those of the image processing apparatus shown in FIG. 1. Thus, like parts are designated by like numerals, and hence their description is omitted.

Here, in the image processing apparatus of Embodiments 1 through 8 and the image forming apparatus of Embodiment 9, the specified region in which chromatic (color) output or image formation is to be restricted has been rectangular. However, the present invention is not limited to this. That is, the region may have various shapes such as a circle (its center and radius are specified) and a rhombus.

Further, in the image processing apparatus of Embodiments 1 through 8 and the image forming apparatus of Embodiment 9, an automatic document feeder has been provided so that a plurality of manuscript sheets fed from the automatic document feeder have been read successively. However, the present invention is not limited to this. That is, a plurality of manuscript sheets may be read one by one.

Further, in the image processing apparatus of Embodiments 1 through 8 and the image forming apparatus of Embodiment 9, when it has been determined that the pixel-deleted image data or the processed image data is not achromatic (that is, chromatic), the read-out manuscript has been determined as a color manuscript so that output or image formation has been performed with considering the pixel-deleted image data or the processed image data as chromatic. However, the present invention is not limited to this. That is, when it is determined that the pixel-deleted image data or the processed image data is not achromatic (that is, chromatic), it may be determined whether the color information of the entire pixels is in a single color (monochrome). As a result of determination, when the pixels are monochrome (for example, in a single blue color), the read-out manuscript may be determined as a monochrome manuscript instead of a color manuscript, so that output or image formation may be performed with considering the pixel-deleted image data or the processed image data as achromatic.

Further, in Embodiments 1 through 8, the image processing apparatus of the present invention has been applied to a multi-functional machine having a scanner function and a facsimile function. However, the present invention is not limited to this. That is, the image processing apparatus of the present invention may be applied to an apparatus having a single function selected from a scanner function and a facsimile function, that is, to an apparatus serving simply as a scanner apparatus or a facsimile machine (transmitting side).

Further, the image forming apparatus of Embodiment 9 has been such an apparatus that the image forming section 15 performs image formation by electrophotography. However, the present invention is not limited to this. That is, the image forming section 15 may perform image formation by an inkjet method.

Further, the image forming apparatus of Embodiment 9 has performed image formation by processing read-out image data. However, the present invention is not limited to this. That is, image formation may be performed by applying processing similar to that for the read-out image data onto image data received from an external apparatus (such as a computer, a scanner apparatus, and a facsimile machine).

Further, in Embodiment 9, the image forming apparatus of the present invention has been applied to a multi-functional machine having a scanner function, a copy function, a print function, and a facsimile function. However, the present invention is not limited to this. That is, the image forming apparatus of the present invention may be applied to an apparatus having a single function selected from a copy function, a print function, and a facsimile function, that is, to an apparatus serving simply as a copy machine, a printer, or a facsimile machine (transmitting/receiving side). Claims 1-19. (Canceled)

20. An image processing apparatus, comprising:
a reading section for reading a manuscript;
a processing section for processing read-out image data of the manuscript read by said reading section;
an output section for outputting processed image data processed by said processing section;
a receiving section for receiving specification of an arbitrary image region of the manuscript; and
a determination section for determining whether pixels of the read-out image data in a region other than the specified region received by said receiving section is achromatic;
wherein when said determination section determines as achromatic, said processing section converts chromatic pixels of the read-out image data in the specified region into achromatic pixels.

21. An image processing apparatus, comprising:
a reading section for reading a manuscript;
a processing section for processing read-out image data of the manuscript read by said reading section;
an output section for outputting processed image data processed by said processing section; and
a receiving section for receiving specification of an arbitrary image region of the manuscript;
wherein said processing section converts, into achromatic pixels, chromatic pixels of the read-out image data in the specified region received by said receiving section.

22. An image processing apparatus, comprising:
a reading section for reading a manuscript;
a processing section for processing read-out image data of the manuscript read by said reading section;
an output section for outputting processed image data processed by said processing section; and
a determination section for determining whether color information of pixels of the read-out image data corresponds to color information of pixels of chromatic image data generated by registering a chromatic image as data;
wherein when said determination section determines as corresponding, said processing section converts, into achromatic pixels, chromatic pixels of the read-out image data corresponding to the color information of the pixels of the chromatic image data.

23. The image processing apparatus according to claim 22, further comprising
a receiving section for receiving specification of a region of the chromatic image,
wherein said determination section determines whether color information of pixels of the read-out image data in the specified region received by said receiving section corresponds to the color information of the pixels of the chromatic image data.

24. The image processing apparatus according to claim 22, further comprising
a difference determination section for determining whether a difference between the color information of the pixels of the read-out image data and the color information of the pixels of the chromatic image data falls within a predetermined range,
wherein when said difference determination section determines that the difference falls within the predetermined range, said processing section converts the pixels of the read-out image data into achromatic pixels.

25. The image processing apparatus according to claim 22, wherein
the chromatic image data further includes a positioning mark for establishing alignment with the read-out image data,
said image processing apparatus further comprising:
a positioning mark extracting section for extracting a positioning mark from read-out image data generated by said reading section reading the manuscript provided with the positioning mark; and
an alignment section for establishing alignment between the positioning mark extracted by said positioning mark extracting section and the positioning mark of the chromatic image data;
wherein after the alignment between both positioning marks performed by said alignment section, said processing section deletes the positioning mark of the read-out image data.

26. The image processing apparatus according to claim 22, wherein
the chromatic image data is read-out image data generated by said reading section reading the manuscript provided with a chromatic image.

27. The image processing apparatus according to claim 20, wherein
said reading section can successively read a plurality of manuscript sheets.

28. The image processing apparatus according to claim 21, wherein
said reading section can successively read a plurality of manuscript sheets.

29. The image processing apparatus according to claim 22, wherein
said reading section can successively read a plurality of manuscript sheets.

30. The image processing apparatus according to claim 20, further comprising
a read-out image data storing section for storing one or a plurality of the read-out image data pieces.

31. The image processing apparatus according to claim 21, further comprising
a read-out image data storing section for storing one or a plurality of the read-out image data pieces.

32. The image processing apparatus according to claim 22, further comprising
a read-out image data storing section for storing one or a plurality of the read-out image data pieces.

33. The image processing apparatus according to claim 20, further comprising
an acquiring section for acquiring image data, chromatic image data, and a specified region transmitted from an external apparatus via a network,
wherein said processing section further processes the image data acquired by said acquiring section.

34. The image processing apparatus according to claim 21, further comprising
an acquiring section for acquiring image data, chromatic image data, and a specified region transmitted from an external apparatus via a network,
wherein said processing section further processes the image data acquired by said acquiring section.

35. The image processing apparatus according to claim 22, further comprising
an acquiring section for acquiring image data, chromatic image data, and a specified region transmitted from an external apparatus via a network,
wherein said processing section further processes the image data acquired by said acquiring section.

36. The image processing apparatus according to claim 22, further comprising:
a chromatic image data storing section for storing one or a plurality of the chromatic image data pieces; and
a chromatic image data selecting section for selecting one or a plurality of the chromatic image data pieces stored in said chromatic image data storing section.

37. The image processing apparatus according to claim 36, wherein
said chromatic image data storing section stores the chromatic image data in correspondence to a chromatic image data identification code assigned to the chromatic image data,
said image processing apparatus further comprising
a chromatic image data identification code extracting section for extracting a chromatic image data identification code from the read-out image data generated by said reading section reading the manuscript provided with the chromatic image data identification code,
wherein on the basis of the chromatic image data identification code extracted by said chromatic image data identification code extracting section, said chromatic image data selecting section selects one or a plurality of the chromatic image data pieces stored in said chromatic image data storing section, and
wherein after the selection of the chromatic image data performed by said chromatic image data selecting section, said processing section deletes the chromatic image data identification code of the read-out image data.

38. The image processing apparatus according to claim 27, further comprising
a manuscript determination section for determining whether any manuscript to be read is present,
wherein when said manuscript determination section determines as present, the chromatic image data is read-out image data generated by said reading section reading a first manuscript sheet,
wherein after said reading section reads the first manuscript sheet, said manuscript determination section determines whether any manuscript still remains, and
wherein when said manuscript determination section determines as remaining, said processing section processes read-out image data generated by said reading section reading the remaining manuscript.

39. The image processing apparatus according to claim 28, further comprising
a manuscript determination section for determining whether any manuscript to be read is present,
wherein when said manuscript determination section determines as present, the chromatic image data is read-out image data generated by said reading section reading a first manuscript sheet,
wherein after said reading section reads the first manuscript sheet, said manuscript determination section determines whether any manuscript still remains, and
wherein when said manuscript determination section determines as remaining, said processing section processes read-out image data generated by said reading section reading the remaining manuscript.

40. The image processing apparatus according to claim 29, further comprising
a manuscript determination section for determining whether any manuscript to be read is present,
wherein when said manuscript determination section determines as present, the chromatic image data is read-out image data generated by said reading section reading a first manuscript sheet,
wherein after said reading section reads the first manuscript sheet, said manuscript determination section determines whether any manuscript still remains, and
wherein when said manuscript determination section determines as remaining, said processing section processes read-out image data generated by said reading section reading the remaining manuscript.

41. The image processing apparatus according to claim 20, further comprising:
a specified region storing section for storing one or a plurality of the specified regions; and
a specified region selecting section for selecting one or a plurality of the specified regions stored in said specified region storing section.

42. The image processing apparatus according to claim 21, further comprising:
a specified region storing section for storing one or a plurality of the specified regions; and
a specified region selecting section for selecting one or a plurality of the specified regions stored in said specified region storing section.

43. The image processing apparatus according to claim 41, wherein
said specified region storing section stores the specified region in correspondence to a specified region identification code assigned to the specified region,
said image processing apparatus further comprising
a specified region identification code extracting section for extracting a specified region identification code from the read-out image data generated by said reading section reading the manuscript provided with the specified region identification code,
wherein on the basis of the specified region identification code extracted by said specified region identification code extracting section, said specified region selecting section selects one or a plurality of the specified regions stored in said specified region storing section, and
wherein after the selection of the specified region performed by said specified region selecting section, said processing section deletes the specified region identification code of the read-out image data.

44. The image processing apparatus according to claim 42, wherein
said specified region storing section stores the specified region in correspondence to a specified region identification code assigned to the specified region,
said image processing apparatus further comprising
a specified region identification code extracting section for extracting a specified region identification code from the read-out image data generated by said reading section reading the manuscript provided with the specified region identification code,
wherein on the basis of the specified region identification code extracted by said specified region identification code extracting section, said specified region selecting section selects one or a plurality of the specified regions stored in said specified region storing section, and
wherein after the selection of the specified region performed by said specified region selecting section, said processing section deletes the specified region identification code of the read-out image data.

45. An image forming apparatus, comprising:
an image processing apparatus according to claim 20; and
an image forming unit for performing image formation on a recording medium on the basis of the processed image data processed by said processing section of said image processing apparatus.

46. An image forming apparatus, comprising:
an image processing apparatus according to claim 21; and
an image forming unit for performing image formation on a recording medium on the basis of the processed image data processed by said processing section of said image processing apparatus.

47. An image forming apparatus, comprising:
an image processing apparatus according to claim 22; and
an image forming unit for performing image formation on a recording medium on the basis of the processed image data processed by said processing section of said image processing apparatus.

48. An image processing method of reading a manuscript and then processing read-out image data of the read-out manuscript, comprising the steps of:
receiving specification of an arbitrary image region of the manuscript;
determining whether pixels of the read-out image data in a region other than the received specified region are achromatic; and
converting chromatic pixels of the read-out image data in the specified region into achromatic pixels, when determined as achromatic.

49. An image processing method of reading a manuscript and then processing read-out image data of the read-out manuscript, comprising the steps of:
receiving specification of an arbitrary image region of the manuscript; and
converting chromatic pixels of the read-out image data in the received specified region into achromatic pixels.

50. An image processing method of reading a manuscript and then processing read-out image data of the read-out manuscript, comprising the steps of:
determining whether color information of pixels of the read-out image data corresponds to color information of pixels of chromatic image data generated by registering a chromatic image as data; and
converting chromatic pixels of the read-out image data corresponding to the color information of the pixels of the chromatic image data, into achromatic pixels when determined as corresponding.
